(19) United States
(12) Patent Application Publication
(10) Pub. No.: US 2026/0197829 A1
(43) Pub. Date: Jul. 9, 2026

(54) UPLINK ACCESS FOR AMBIENT POWER (AMP) CLIENTS

(71) Applicant: QUALCOMM Incorporated, San Diego, CA (US)

(72) Inventors: Sanket Sanjay KALAMKAR, San Diego, CA (US); George CHERIAN, San Diego, CA (US); Alfred ASTERJADHI, San Diego, CA (US)

(21) Appl. No.: 19/012,781

(22) Filed: Jan. 7, 2025

(51) Int. Cl. H04W 72/21

(52) U.S. Cl. CPC H04W 72/21

(57) ABSTRACT

This disclosure provides methods, components, devices and systems for uplink access for ambient power (AMP) devices. Some aspects more specifically relate to solicitation of a response from an AMP device in a shared medium subject to carrier sense type channel access. An access point or a reader device may transmit a control or trigger frame which solicits the response and indicates one or more resources associated with uplink access for the response in the shared medium subject to carrier sense type channel access. The AMP device may perform uplink access in the shared medium to transmit the solicited response. The type of control frame may depend on the purpose of the communication. The timing of the response to a unicast or multicast control frame may be based on the reception time of the control frame. The control frame may provide a reference time for uplink access for AMP devices.

### TECHNICAL FIELD

This disclosure relates generally to wireless communication and, more specifically, to uplink access for ambient power clients.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by an access point (AP). The method may include transmitting a control frame that solicits a response from an ambient power (AMP) client device, where the control frame is indicative of one or more resources associated with uplink access for the response in a shared medium subject to carrier sense type channel access and receiving, based on the control frame, the response from the AMP client device.

Another innovative aspect of the subject matter described in this disclosure can be implemented in an AP for wireless communications. The AP may include a processing system that includes processor circuitry and memory circuitry that stores code. The processing system may be configured to cause the AP to transmit a control frame that solicits a response from an AMP client device, where the control frame is indicative of one or more resources associated with uplink access for the response in a shared medium subject to carrier sense type channel access and receive, based on the control frame, the response from the AMP client device.

Another innovative aspect of the subject matter described in this disclosure can be implemented in another AP for wireless communications. The AP may include means for transmitting a control frame that solicits a response from an AMP client device, where the control frame is indicative of one or more resources associated with uplink access for the response in a shared medium subject to carrier sense type channel access and means for receiving, based on the control frame, the response from the AMP client device.

Another innovative aspect of the subject matter described in this disclosure can be implemented in a non-transitory computer-readable medium storing code for wireless communications. The code may include instructions executable by one or more processors to transmit a control frame that solicits a response from an AMP client device, where the control frame is indicative of one or more resources associated with uplink access for the response in a shared medium subject to carrier sense type channel access and receive, based on the control frame, the response from the AMP client device.

Some examples of the method, APs, and non-transitory computer-readable medium described herein may further include operations, features, means, or instructions for transmitting an energizing signal to the AMP client device, where reception of the response may be based on transmission of the energizing signal.

In some examples of the method, APs, and non-transitory computer-readable medium described herein, the control frame includes a unicast control frame including an identifier associated with the AMP client device and the control frame may be indicative of the one or more resources being an interframe space duration after the control frame based on the control frame being the unicast control frame.

In some examples of the method, APs, and non-transitory computer-readable medium described herein, a receive time of the control frame at the AMP client device includes a reference time with respect to the one or more resources.

In some examples of the method, APs, and non-transitory computer-readable medium described herein, transmitting the control frame may include operations, features, means, or instructions for broadcasting or multicasting the control frame, where the one or more resources include a set of resources indicated by the control frame as available for uplink random access, the method further including monitoring for responses from AMP client devices in the set of resources, the response received in a resource of the set of resources based on the monitoring.

Some examples of the method, APs, and non-transitory computer-readable medium described herein may further include operations, features, means, or instructions for transmitting, via the control frame or an energizing signal associated with a transmission opportunity that includes the set of resources, an indication of a respective access probability for each resource of the set of resources.

In some examples of the method, APs, and non-transitory computer-readable medium described herein, the set of resources may be a set of slots or a set of frequency resources in a same slot.

Some examples of the method, APs, and non-transitory computer-readable medium described herein may further include operations, features, means, or instructions for transmitting an interrogating signal during the one or more resources, where the response may be a backscatter response.

Another innovative aspect of the subject matter described in this disclosure can be implemented in a method for wireless communications by an AMP client device. The method may include receiving, from an AP, a control frame that solicits a response from the AMP client device, where the control frame is indicative of one or more resources associated with uplink access for the response in a shared medium subject to carrier sense type channel access and performing uplink access based on the control frame to transmit the response to the AP.

Another innovative aspect of the subject matter described in this disclosure can be implemented in an AMP client device for wireless communications. The AMP client device may include a processing system that includes processor circuitry and memory circuitry that stores code. The processing system may be configured to cause the AMP client device to receive, from an AP, a control frame that solicits a response from the AMP client device, where the control frame is indicative of one or more resources associated with uplink access for the response in a shared medium subject to carrier sense type channel access and perform uplink access based on the control frame to transmit the response to the AP.

Another innovative aspect of the subject matter described in this disclosure can be implemented in another AMP client device for wireless communications. The AMP client device may include means for receiving, from an AP, a control frame that solicits a response from the AMP client device, where the control frame is indicative of one or more resources associated with uplink access for the response in a shared medium subject to carrier sense type channel access and means for performing uplink access based on the control frame to transmit the response to the AP.

Another innovative aspect of the subject matter described in this disclosure can be implemented in a non-transitory computer-readable medium storing code for wireless communications. The code may include instructions executable by one or more processors to receive, from an AP, a control frame that solicits a response from the AMP client device, where the control frame is indicative of one or more resources associated with uplink access for the response in a shared medium subject to carrier sense type channel access and perform uplink access based on the control frame to transmit the response to the AP.

Some examples of the method, AMP client devices, and non-transitory computer-readable medium described herein may further include operations, features, means, or instructions for receiving an energizing signal, where transmission of the response may be based on reception of the energizing signal.

In some examples of the method, AMP client devices, and non-transitory computer-readable medium described herein, the control frame includes a unicast control frame including an identifier associated with the AMP client device and the control frame may be indicative of the one or more resources being an t interframe space duration after the control frame based on the control frame being the unicast control frame.

In some examples of the method, AMP client devices, and non-transitory computer-readable medium described herein, a receive time of the control frame at the AMP client device includes a reference time with respect to the one or more resources.

In some examples of the method, AMP client devices, and non-transitory computer-readable medium described herein, the control frame may be a broadcast control frame or a multicast control frame, the one or more resources include a set of resources indicated by the control frame as available for uplink random access, and the response may be transmitted in a resource of the set of resources.

Some examples of the method, AMP client devices, and non-transitory computer-readable medium described herein may further include operations, features, means, or instructions for selecting the resource from the set of resources in accordance with respective access probabilities for each resource of the set of resources.

Some examples of the method, AMP client devices, and non-transitory computer-readable medium described herein may further include operations, features, means, or instructions for receiving, from the AP via the control frame or an energizing signal associated with a transmission opportunity that includes the set of resources, an indication of the respective access probabilities.

In some examples of the method, AMP client devices, and non-transitory computer-readable medium described herein, the set of resources may be a set of slots or a set of frequency resources in a same slot.

Some examples of the method, AMP client devices, and non-transitory computer-readable medium described herein may further include operations, features, means, or instructions for receiving an interrogating signal during the one or more resources, where the response may be a backscatter response.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a pictorial diagram of another example wireless communication network.

FIGS. 4A and 4B show examples of signaling diagrams that supports uplink access for ambient power (AMP) clients.

FIG. 5 shows an example of an AMP operation flow diagram that supports uplink access for AMP clients.

FIG. 6 shows an example of a timing diagram that supports uplink access for AMP clients.

FIG. 7 shows an example of a timing diagram that supports uplink access for AMP clients.

FIG. 8 shows an example of a timing diagram that supports uplink access for AMP clients.

FIG. 9 shows an example of a timing diagram that supports uplink access for AMP clients.

FIG. 10 shows an example of a timing diagram that supports uplink access for AMP clients.

FIG. 11 shows an example of a process flow that supports uplink access for AMP clients.

FIG. 12 shows a block diagram of an example wireless communication device that supports uplink access for AMP clients.

FIG. 13 shows a block diagram of an example wireless communication device that supports uplink access for AMP clients.

FIG. 14 shows a flowchart illustrating an example process performable by or at an AP that supports uplink access for AMP clients.

FIG. 15 shows a flowchart illustrating an example process performable by or at an AMP client device that supports uplink access for AMP clients.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support various deployments for ambient power-enabled communications (such as ambient power (AMP) deployments). In such deployments, one or more wireless communication devices may lack an internal power source (such as a battery) or may otherwise have relatively limited energy storage and/or other capabilities. Such devices may perform energy harvesting using one or more energy sources and/or signals to communicate data. In some examples, these devices may be relatively low-complexity devices (such as due to an environment in which the device operates, due to a functionality of the device, due to a form factor of the device, due to a relatively reduced cost of the device, among other examples) and may be referred to as AMP devices, AMP client devices, energy-harvesting devices, AMP tags, low-power devices, zero-power devices, AMP-enabled Internet of Things (IoT) devices, or the like.

Deployments including one or more AMP devices may be associated with various configurations for supporting energy harvesting and AMP-enabled communications. For example, one or more devices (such as one or more access points (APs), stations (STAs), relays, readers, or the like) may provide a signal (such as an energizing signal, an energizer signal, an excitation signal) to an AMP device such that the AMP device harvests the energy from the signal and supplies power to (for example, powers up, activates) one or more radio frequency (RF) components of the AMP device for communications. After the RF components are powered up, data may be communicated between the AMP device and the one or more devices that provided the signal. Additionally, or alternatively, the AMP device may communicate with one or more other devices (such as one or more APs, STAs, relays, readers, or the like) that did not provide the energizing signal. In some examples, one or more additional devices (such as energizers, energizing devices), which may not communicate control information or data with the AMP device, may supply the energizing signals that are used for energy harvesting at the AMP devices. AMP devices may have limited or minimal memory, and may suffer from clock drift (such as a clock drift of 1000 to 100000 parts per million (ppm)).

Various aspects relate generally to solicitation of response from an AMP device in a shared medium (for example, a medium subject to carrier sense type channel access). Some aspects more specifically relate to transmission by an AP (such as a reader device) of a control or trigger frame which solicits the response(s) from the AMP device(s) and is indicative of one or more resources associated with uplink access for the response in the shared medium. An AMP device may accordingly perform uplink access in the shared medium to transmit the solicited response. In some examples, the type of control frame may depend on the purpose of the communication. For example, a control frame to solicit an initial access response and/or identify AMP client devices may be broadcast, and the AMP devices may use random access techniques to transmit in randomly selected resources from a set of resources indicated by the broadcast control frame. For example, the set of resources may be a set of frequency resources within a same time slot, or a set of multiple time slots. After the AP identifies AMP client devices, the AP may solicit responses from specific AMP client devices using identifiers for the specific AMP client devices (such as medium access control (MAC) addresses) using unicast or multicast control frames. The timing of the response to a unicast or multicast control frame may be based on the reception time of the control frame, and thus the control frame may provide a reference time for AMP devices.

Particular aspects of the subject matter described in this disclosure can be implemented to realize one or more of the following potential advantages. In some examples, by soliciting response(s) from AMP devices using control or trigger frames that indicate a resource for uplink access, AMP devices may attempt to access the shared medium to transmit in a resource expected by the AP. Accordingly, the AP may monitor particular resource(s) for expected responses from the AMP devices. By implementing random access schemes for initial access, the AP may identify AMP devices and may subsequently schedule unicast or multicast communications with identified AMP devices. By using the reception time of the control frame or the reference time indicated in the control frame as a reference time, the AMP devices may synchronize timing with the AP to mitigate the effect of clock drift at the AMP devices.

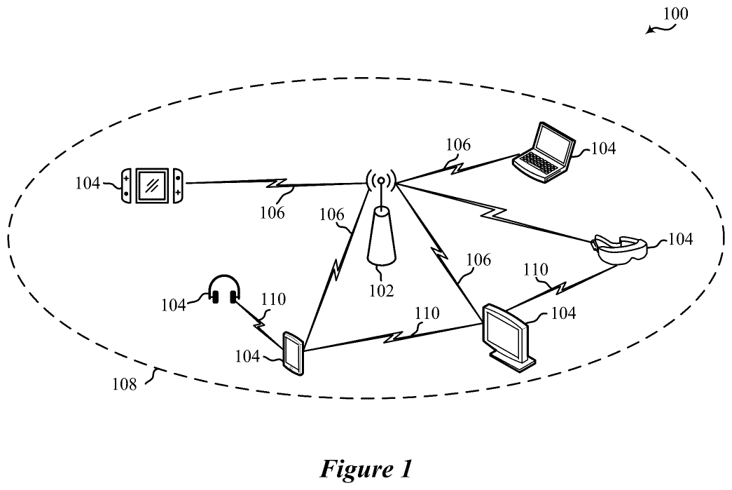

FIG. 1 shows a pictorial diagram of an example of a wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a transmission opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

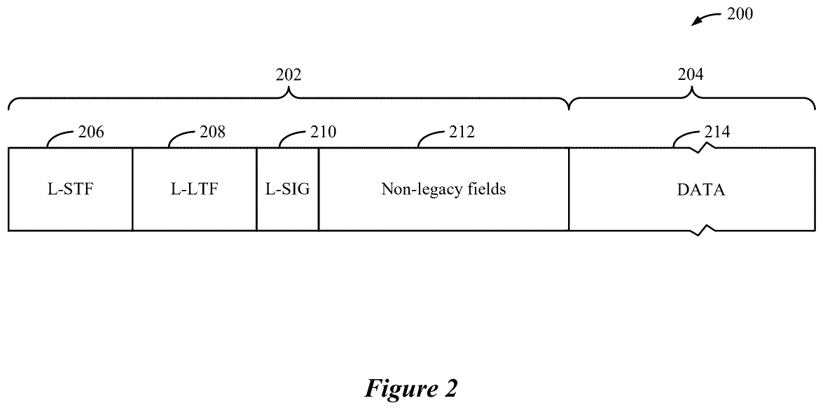

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (ACK) (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

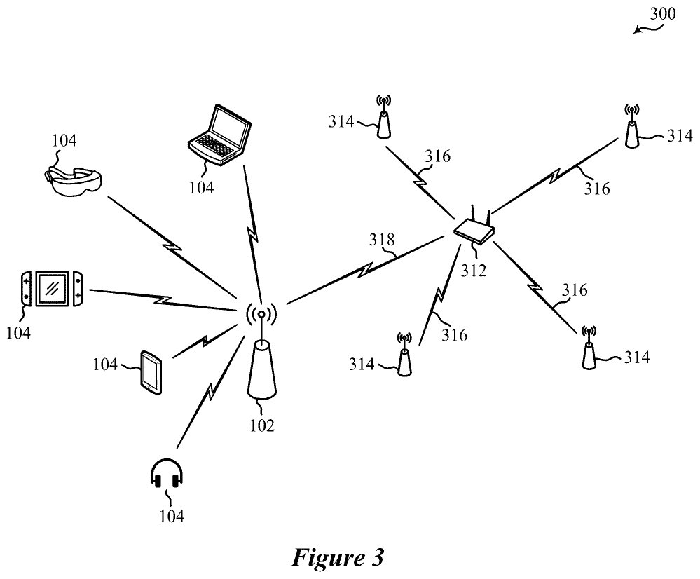

FIG. 3 shows a pictorial diagram of another example wireless communication network 300. According to some aspects, the wireless communication network 300 can be an example of a mesh network, an IoT network, or a sensor network in accordance with one or more of the IEEE 802.11 family of wireless communication protocol standards (including the 802.11ah amendment). The wireless communication network 300 may include wireless communication devices 314, which in some implementations may include APs 102, STAs 104, or both. The wireless communication devices 314 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 314 sense, measure, collect or otherwise obtain and process data and transmit such raw or processed data to an intermediate device 312 for subsequent processing or distribution. Additionally, or alternatively, the intermediate device 312 may transmit control information, digital content (for example, audio or video data), configuration information or other instructions to the wireless communication devices 314. The intermediate device 312 and the wireless communication devices 314 can communicate with one another via wireless communication links 316. In some examples, the wireless communication links 316 include Bluetooth links or other PAN or short-range communication links.

In some examples, the intermediate device 312 also may be configured for wireless communication with other networks such as with a WLAN or a wireless (for example, cellular) wide area network (WWAN), which may, in turn, provide access to external networks including the Internet. For example, the intermediate device 312 may associate and communicate, over a Wi-Fi link 318, with an AP 102 of a wireless communication network 300, which also may serve various STAs 104. In some examples, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some examples, the intermediate device 312 can analyze, preprocess and aggregate data received from the wireless communication devices 314 locally at the edge before transmitting it to other devices or external networks via the Wi-Fi link 318. The intermediate device 312 also can provide additional security for the IoT network and the data it transports.

In some examples, one or more wireless communication devices may not have an internal battery or may have a relatively limited battery supply or other source of power. As such, these devices may be relatively lower-complexity devices associated with relatively reduced power consumption for wireless communications, for example, via unlicensed (for example, shared) RF spectrum bands. As an example, one or more environmental conditions (such as extreme environmental conditions, such as relatively high pressure, extremely high and/or low temperature, humid environments, to name a few) may make the inclusion of a battery in a wireless communication device unfeasible. In another example, various use cases may call for a relatively low-maintenance (or maintenance-free) wireless communication device. As such, these wireless communication devices may not include a battery so as to avoid regular battery replacement or other maintenance. Additionally, or alternatively, a form factor or other features (such as a device having relatively small dimensions (such as a thickness of 1 millimeter (mm) and area of several square centimeters), a low-cost device, a device associated with an extended life cycle, or the like) may result in the exclusion of a battery or other power source from the wireless communication device. In some examples, these devices may be relatively low-cost devices (such as a tag used for tracking and inventory). Such devices may have a variety of example use cases, including home monitoring (such as monitoring temperature, humidity, gas leakage), home security (such as detecting intruders approaching a residence), asset management (such as asset tracking, inventory), industrial and/or scientific applications (such as industrial wireless sensor networks, product line monitoring, environment monitoring), to name a few. In some examples, these devices may be referred to as AMP wireless devices, energy-harvesting devices, AMP tags, low-power devices, zero-power devices, AMP-enabled IoT devices, AMP devices, or the like.

These devices having limited (or no) battery or other power source may accordingly be associated with relatively reduced power consumption (for example, ultra-low power consumption, less than 1 milliwatt (mW) power consumption, less than 100 microwatts (μW) power consumption), relatively low complexity (for example, having a relatively simplified RF and baseband architecture, limited memory, or the like), and relatively reduced performance (for example, utilizing relatively simplified waveform/modulation/coding schemes, relatively simplified protocol designs to support ultra-low power operation, or the like). As a result, the devices may use other means to power one or more RF components and/or integrated circuits (ICs) for wireless communications. For example, an AMP wireless device may be powered via techniques such as energy harvesting from radio waves or other power sources. Such energy harvesting may utilize various sources of energy including electromagnetic energy sources, photovoltaic energy sources, thermal energy sources, vibrational energy sources, or a combination of these sources, among other examples. In one implementation, ambient energy from one or more RF spectrum bands (for example, a 2.4 Gigahertz (GHz) band or a sub-1 GHz band, among others) may be used by a device to supply power to one or more RF components that are configured for wireless communications with one or more other devices (such as an AP 102, a STA 104, among other examples, each of which may be referred to as a reader). The device harvesting the energy may include one or more RF components associated with energy harvesting (for example, for receiving the signal(s) used to supply power) in addition to a set of RF components (for example, a main radio) used for the wireless communications. In other examples, the set of RF components may be used for both energy harvesting and wireless communications. The devices may access the shared medium using techniques described herein, such as CSMA/CA, in order to transmit uplink data.

In some examples, AMP wireless devices may be configured to support backscatter communication techniques. Backscatter communication techniques may involve a single waveform, which may define the structure and shape of information in transmitted signals, where a received signal is reflected (or backscattered) to enable one or more data transmissions. In some examples, backscatter communication techniques may use a continuous wave, which may be a sinusoidal wave that is modulated with an information-bearing signal to convey information. For example, one or more wireless devices (for example, a transmitting device, such as an AP 102 or a STA 104, and which may be referred to as a reader or other terminology) may select a waveform to use to modulate the carrier wave. Devices performing backscatter communications may similarly use techniques described herein to access the shared medium, such as CSMA/CA, in order to transmit uplink data using backscatter modulation.

The continuous wave transmission to an AMP wireless device may enable the AMP wireless device to collect energy from the continuous wave transmission. The collected energy at the AMP wireless device may reach some voltage (for example, IC voltage on) at which point the AMP wireless device may turn on (for example, power up an IC, activate, supply power to). In some examples, the continuous wave transmission may be transmitted for some duration to power up the AMP wireless device. After the duration, the transmitting device (or another device) may transmit an information signal (for example, including one or more commands) to the AMP wireless device, where the information signal also may enable the AMP wireless device to harvest energy and remain active (for example, powered on). The one or more commands may include instructions for the AMP wireless device to transmit some signaling or information requested by the transmitting device. The transmitting device may transmit the continuous wave transmission to maintain the applied power (for example, powered up) state of the AMP wireless device until a response to the one or more commands from the AMP wireless device is received. In some examples, powering up the AMP wireless device, maintaining the powered up state of the AMP wireless device, and transmitting the power and carrier wave for modulation may use a same waveform.

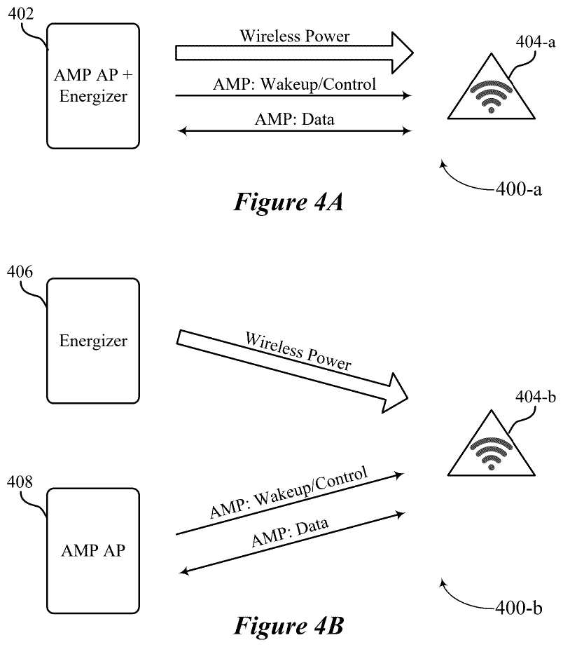

FIGS. 4A and 4B show example signaling diagrams 400 (for example, a signaling diagram 400-a and a signaling diagram 400-b) that support uplink access for AMP clients. In some aspects, the signaling diagrams 400 may be examples of networks that support AMP-enabled wireless communications. As such, each signaling diagram 400 may be an example of a respective deployment or configuration of one or more devices that enable the AMP-enabled wireless communications. For example, each signaling diagram 400 may include an AMP device 404 (for example, an energy-harvesting device, an AMP tag, a low-power device, an AMP IoT device, an AMP device) and one or more other devices that provide an energizing signal (for example, an energizer signal) to the AMP device 404 and/or communicate data with the AMP device 404.

In some examples, an AMP device 404 may support one or more types of configurations for wireless communications. For example, in a first type of configuration of the AMP device 404, the AMP device 404 may only include RF components for AMP-enabled communications (for example, an AMP radio). Here, the AMP device 404 may lack support of, or functionality for, some types of data (for example, device initiated TXOP, request to send (RTS), clear to send (CTS)). In such cases, the AMP device 404 may communicate data with one or more other devices using the RF components associated with the AMP-enabled communications (for example, associated with energy harvesting or other low-power communication techniques). In a second type of configuration of the AMP device 404, the AMP device 404 may only include the RF components for the ambient-power-enabled communications but may support the exchange of various types of data frames for communicating data (such as TCP data frames, IP data frames, QoS data frames, among other examples). In a third type of configuration, the AMP device 404 may include the RF components associated with the AMP-enabled communications, as well as RF components that support wireless communications in accordance with the IEEE 802.11 family of wireless communication protocol standards (for example, a main radio, an 802.11-capable radio, or the like). In such examples, the AMP device 404 may support the AMP-enabled communications and various types of data transmission (such as TCP data, IP data, QoS data, among other examples) using one or more sets of RF components.

As illustrated in the pictorial diagram of FIG. 4A, the example signaling diagram 400-a may include a wireless communication device 402 and an AMP device 404-a. The wireless communication device 402 may provide power to the AMP device 404-a and communicate control signals and/or data with the AMP device 404-a. For example, the wireless communication device 402 may transmit one or more signals (for example, energizing signals) that are used by the AMP device 404-a to harvest energy from the signal(s) and supply power to one or more RF components of the AMP device 404-a for communications with the wireless communication device 402. Further, after the AMP device 404-a supplies power to the one or more RF components (for example, powers up at least one AMP radio) using the harvested energy, the wireless communication device 402 may transmit one or more wakeup signals and/or control signals for enabling communications between the AMP device 404-a and the wireless communication device 402. For example, the one or more wakeup signals and/or control signals may serve as energizing signals for the AMP devices as described herein. The wakeup signals and/or control signals may be received and/or processed by the AMP device 404-a via RF components associated with the AMP-enabled communications (for example, an AMP radio, an AMP transceiver). The AMP device 404-a may communicate data with the wireless communication device 402 via the AMP radio. In some aspects, if there is no data to be communicated, the one or more energizing signals may be stopped (for example, paused, halted, interrupted), and the AMP device 404-a may subsequently power down (for example, due to an absence of power available for harvesting, until the one or more energizing signals are transmitted/received again). In some aspects, one or more servers (for example, a reader device may be connected to a server capable of communication with the Internet or a cloud interface) may be connected to or otherwise in communication with the wireless communication device 402. In such implementations, the one or more servers may communicate with the wireless communication device 402, such as one or more query messages and/or one or more response messages associated with communicating with the AMP device 404-a.

In some aspects, the wireless communication device 402 may be referred to as a reader, AMP reader, or reader device, and the wireless communication device 402 may be an example of an AP (such as an AP 102), a network entity, a STA (such as a STA 104), a handheld device, a smart phone, a specialized AMP reader, or another device. Additionally, or alternatively, the wireless communication device 402 may be referred to as an AMP AP and/or energizer, which may support both the transmission of energizing signals to the AMP device 404-a and data exchange with the AMP device 404-a.

In FIG. 4B, the pictorial diagram of the example signaling diagram 400-b includes an energizer device 406 and a wireless communication device 408, where the energizer device 406 and the wireless communication device 408 are configured to support AMP-enabled communications with an AMP device 404-b. The energizer device 406 (for example, energizer) may be configured to transmit one or more signals (for example, energizing signals) that are used by the AMP device 404-b to harvest energy and supply power to one or more RF components of the AMP device 404-a for communications with the wireless communication device 408. In such examples, the energizer device 406 may enable persistent or semi-persistent energy harvesting (for example, relatively long-term energy harvesting) for the AMP device 404-b. As such, the AMP device 404-b may be supplied with power in an approximately continuous manner, thereby enabling extended communications sessions (for example, the communication sessions may be expected to be maintained for some duration).

After the AMP device 404-b supplies power to the one or more RF components (for example, powers up at least one AMP radio) using the energizing signal(s) from the energizer device 406, the wireless communication device 408 may transmit one or more wakeup signals and/or control signals to enable communications between the AMP device 404-b and the wireless communication device 408. The wakeup signals and/or control signals may be received and/or processed by the AMP device 404-b using one or more RF components associated with the AMP-enabled communications (for example, an AMP radio, an AMP transceiver). The AMP device 404-b may communicate data with the wireless communication device 408 via the AMP radio.

The energizer device 406 may be an example of an AP (such as an AP 102), a network entity, a STA (such as a STA 104), a handheld device, a smart phone, a specialized AMP device, or another device. The wireless communication device 408 may be referred to as a reader, AMP reader, or reader device, and the wireless communication device 408 may be an example of an AP (such as an AP 102), a network entity, a STA (such as a STA 104), a handheld device, a smart phone, a specialized AMP reader, or another device. Additionally, or alternatively, the wireless communication device 408 may be referred to as an AMP AP, which supports the exchange of data with the AMP device 404-b.

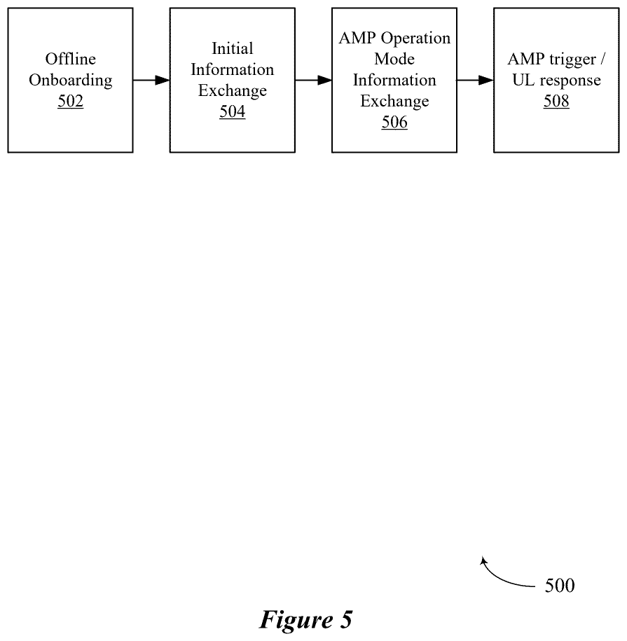

FIG. 5 shows an example of an AMP operation flow diagram 500 that supports uplink access for AMP clients. The AMP operation flow diagram 500 may implement or may be implemented by aspects of the wireless communication network 100, the wireless communication network 300, or the signaling diagrams 400.

AMP devices, such as the AMP devices 404 of FIGS. 4A and 4B may access the channel (for example, the shared medium) when instructed by an AP (such as an AP 102 as described with reference to FIGS. 1 and 3, a wireless communication device 402 as described with reference to FIG. 4A, or a wireless communication device 408 as described with reference to FIG. 4B). AMP devices 404 may be unable to contend for channel access if not instructed to do so by the AP because AMP devices 404 may have capability limitations such as: limited energy availability (such as in the case of battery-less operation); minimal to no persistent (for example, non-volatile) memory (due to low complexity and low-cost nature of AMP devices); and/or high clock drift (due to low complexity and low-cost nature of AMP devices). For example, as described herein, some AMP devices may have a clock drift of 1000 to 100000 ppm. An AP may use a single frame, such as a control frame, a poll frame, or a trigger frame (which may collectively be referred to as control frames), to request a response from one or more AMP client devices. Based on the solicitation from the AP, the one or more AMP client devices may attempt to access the channel after receiving the control frame.

AMP operation may involve multiple phases. A first phase 502 may involve offline onboarding of AMP devices. For example, the first phase 502 may include password setting, which may establish a pairwise master key (PMK) for the AMP device. The first operation may be optional for AMP devices.

A second phase 504 may involve the initial information exchange between the AMP device and the AP. The second phase 504 also may be referred to as discovery. In the second phase 504, the AP and the AMP client may exchange basic information for the first time after offline onboarding (if offline onboarding was performed). For example, such basic information may include the MAC address of the AMP devices. The second phase 504 may be performed in an offline manner in some use cases. For example, an AP may obtain the MAC address of the AMP device via scanning a QR code placed on or next to the AMP device. The AP may use the second phase 504 to determine the presence of AMP client devices.

A third phase 506 may involve AMP operation mode information exchange. For example, the AP may request the AMP device operation capabilities and other detailed information. The AMP device may provide the requested capability information and/or schedule-related information to the AP. For example, the capability and other detailed information may include schedule information (for example, how often the AMP device requests to be awakened by the AP), power budget (for example, maximum transmit power of the AMP device, internal power consumption to operate RF circuitry, etc.), and/or energy harvesting capability information of AMP devices (for example, time required to fully charge capacitor, the duration of the energizing signal required to fully charge the capacitor at a specific transmit power of the energizing signal, leakage of energy from the capacitor, etc.). The AP may use such information to determine the transmit/receive parameters (for example, the duration of the energizing signal before sending a control frame to the AMP device, the transmit power of the AMP device based on the capabilities, the frequency of the transmission of the control frame to the AMP device) to reach the AMP device. Although shown as separate, in some examples, the second phase 504 and the third phase 506, or aspects of the second phase 504 and the third phase 506 may be combined. For example, some or all of the information exchanged in the second phase 504 may be communicated between the AP and the AMP device(s) during the third phase 506, or vice versa. As another example, a single response from an AMP device may convey information associated with the second phase 504 and the third phase 506.

A fourth phase 508 may involve AMP device polling and/or uplink response. In the fourth phase 508, the AP may poll and/or trigger the client for uplink transmissions, and the AMP device may transmit uplink communications. The communications in the fourth operation may be in accordance with the scheduling information/parameters exchanged in the third phase 506.

For the different phases of AMP operation (for example, the first phase 502, the second phase 504, the third phase 506, and the fourth phase 508), the AP (for example, the reader device) may solicit responses from one or more AMP devices. In a unicast example (for example, solicitation of a response from a single AMP device at a time), the AP may send a control/poll frame with a unicast address (for example, a trigger frame). In the unicast example, the AP may expect a response from the AMP device from which the response was solicited within an IFS duration (such as, within a SIFS or PIFS duration) or within the duration T where T>=0.

In a multicast or broadcast example (for example, solicitation of responses from multiple AMP devices), the AP may send a control frame with multicast or broadcast addresses, and multiple AMP devices may perform uplink access. Aspects of this disclosure are related to the uplink access protocol for AMP device(s) in unicast, multicast, and/or broadcast scenarios.

Whether a control frame from an AP is unicast or broadcast/multicast may depend on the purpose of the solicited response, which may depend on the phase of operation (for example, the first phase 502, the second phase 504, the third phase 506, and the fourth phase 508).

For example, in the second phase 504 (initial information exchange or discovery), as the AP may not have information of the MAC address of the AMP device (such as due to the AMP device moving out of the coverage area of the AP or due to sleeping for a long duration), the control frame soliciting a response may be broadcast. As another example, in the third phase 506 (AMP operation mode information exchange) the AP may use a unicast control frame when soliciting information from a single client AMP device, or the AP may use a broadcast/multicast control frame when soliciting information from multiple client AMP devices. As another example, in the fourth phase 508 (poll/uplink response phase) the AP may use a unicast control frame when soliciting information from a single client AMP device, or the AP may use a broadcast/multicast control frame when soliciting information from multiple client AMP devices.

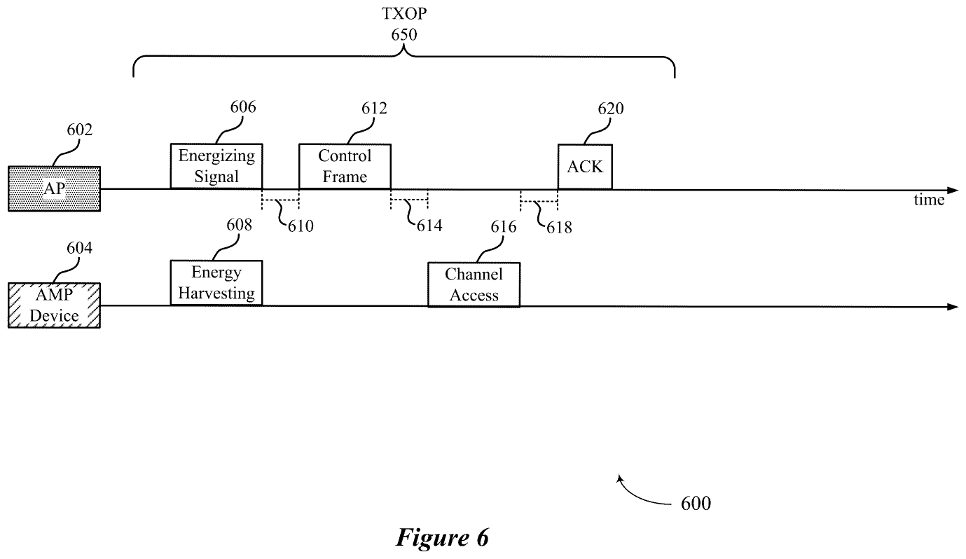

FIG. 6 shows an example of a timing diagram 600 that supports uplink access for AMP clients. The timing diagram 600 may implement or may be implemented by aspects of the wireless communication network 100, the wireless communication network 300, the signaling diagrams 400, or the AMP operation flow diagram 500. For example, the timing diagram 600 may illustrate communications in a unicast example between an AMP device 604 (such as the AMP devices 404 of FIGS. 4A and 4B) and an AP 602 (such as an AP 102 as described with reference to FIGS. 1 and 3, a wireless communication device 402 as described with reference to FIG. 4A, or a wireless communication device 408 as described with reference to FIG. 4B).

For example, unicast communications involving an AMP device 604 may include one client active uplink communication per TXOP 650. In some examples, unicast communications involving an AMP device 604 may include one client with active uplink communication that spans multiple TXOPs. The AMP device 604 may perform energy harvesting 608 on an energizing signal 606. The energizing signal 606 may start before the control frame 612, which may enhance the probability that the AMP device 604 has sufficient energy to receive the control frame and perform channel access 616. In some examples, the energizing signal 606 may end before the control frame 612 (such as a duration 610 such as an IFS duration prior to the control frame 612). In some examples, the energizing signal 606 may not end prior to control frame 612 (for example, the energizing signal 606 may overlap with the control frame 612). The energizing signal 606 may be a sub-1 GHz energizing signal for active uplink cases. The energizing signal 606 may be a carrier signal for backscatter communications. In some examples (such as in FIG. 4A), the AP 602 may be co-located with the energizer (for example, the AP 602 may transmit the energizing signal 606). In some examples (such as in FIG. 4B), the AP 602 may not be co-located with the energizer (for example, a different device than the AP 602 may transmit the energizing signal 606).

In some examples, the control frame 612 may solicit the operation capabilities of the AMP device 604 (for example, during the third phase 506 as described with reference to FIG. 5). In some examples, the control frame 612 may be a PDU as described with reference to FIG. 2 or a PPDU as described herein. For example, the control frame 612 may include one or more fields that include an identifier for the AMP device 604. In some examples, the control frame 612 may solicit the uplink data from the AMP device 604 (for example, during the fourth phase 508 as described with reference to FIG. 5). The control frame 612 may be indicative of a timing for the AMP device 604 to perform channel access to transmit an uplink communication. For example, the AMP device 604 may perform channel access 616 a duration 614 (which may be an IFS duration such as a SIFS duration or a point coordination function inter-frame spacing (PIFS) duration or any duration T where T>=0) after reception of the control frame 612 if the AMP device 604 has sufficient energy to perform the channel access 616. The AP 602 may provide an ACK 620 a duration 618 (which may be an IFS duration such as a SIFS duration or a PIFS duration any duration T where T>=0) after reception of the uplink communication by the AMP device 604. The AMP device 604 may use the receive time of the control frame 612 to determine the timing for the channel access 616. In some examples, a unicast communication (for example, the control frame 612, the channel access 616 for the response to the control frame 612, and/or feedback for the response) may span multiple TXOPs.

In examples where the AP 602 may be co-located with the energizer, the energizing signal 606 itself may act as the control frame 612. For example, the energizing signal 606 may include one or more fields of a PDU or a PPDU as described herein which may identify the AMP device 604 and the energizing signal 606 may include a carrier wave from which the AMP device 604 may harvest energy. For example, once the AMP device 604 harvests enough energy from the energizing signal 606, the AMP device 604 may wake up and perform channel access 616 to transmit the solicited response. In some examples, the AMP device 604 may be hardcoded to send a specific response whenever the AMP device 604 harvests enough energy from the energizing signal and wakes up. In examples where the AP 602 may not be co-located with the energizer, the energizing signal 606 may be separate from the control frame 612. In examples where the AP 602 may not be co-located with the energizer, the AP 602 may indicate to the energizer to begin the energizing signal 606, and once the AMP device 604 harvests enough energy from the energizing signal 606, the AMP device 604 may wake up and perform channel access 616 to transmit the solicited response.

The AP 602 may use a best-effort approach to reach the AMP device 604. For example, the AP 602 may solicit a response from the AMP device 604 based on the schedule information exchanged with the AMP device 604 (such as during the third phase 506 as described with reference to FIG. 5). For example, uplink solicitation may be performed in a duty-cycled manner (such as periodic). As another example, the AP 602 may solicit a response from the AMP device 604 based on events (such as soliciting an uplink retransmission). In some examples, if the AMP device 604 does not perform channel access 616 after the AP 602 sends the control frame 612 that solicits a response from the AMP device 604 during the TXOP 650, the channel medium may become available for other neighboring devices to attempt to gain control of the channel medium. For example, an AMP device 604 may not perform channel access 616 if the AMP device 604 does not have sufficient energy to perform the channel access or if the AMP device is in a sleep state when the AP 602 sends the control frame 612. In some such examples, the AP 602 may reclaim the channel medium, for example, by performing a PIFS recovery. If the AP 602 reclaims the channel medium, the AP 602 may trigger/poll another client device (such as another AMP device) for an uplink response.

The control frame 612 may identify the AMP device 604 via a MAC address for the AMP device 604, which the AMP device 604 may retain in non-volatile memory. Once energized by the energizing signal 606, the AMP device 604 may wait for a control frame 612 that includes the MAC address of the AMP device 604. If the AMP device 604 does not detect a control frame 612 that includes the MAC address of the AMP device 604, the AMP device 604 may go back to sleep until the AMP device 604 is re-energized (for example, receives another energizing signal). In some examples, the AMP device 604 may expect to receive the control frame 612 after a SIFS duration after the energizing signal 606, and accordingly the AMP device 604 may wait for SIFS+T duration, where T>=0 and T may depend on the energy availability of the AMP device 604 (for example, the time at which the energy level of the AMP device 604 falls below a threshold required to complete an uplink transmission). If the AMP device 604 retains a shorter identifier (for example, smaller than a 48-bit MAC address), the AP 602 may use the shorter identifier instead of the MAC address in the control frame 612. For example, the AP 602 may use the shorter identifier in the control frame 612 if the AP 602 is made aware of the shorter identifier for the AMP device 604 during the initial information exchange phase (such as the second phase 504 as described with reference to FIG. 5) or during onboarding (such as during the first phase 502 as described with reference to FIG. 5). In some examples, a short identifier may be similar to an association identifier (AID) in 802.11 networks. For example, a short identifier may be 11 or 12 bits (for example, when the AMP device is co-located with an 802.11 device). In some examples, the short identifier may be a hashed version of the MAC address of the AMP device. In some examples, AMP-only clients may be unable to store a short client identifier in non-volatile memory, but AMP clients co-located with an 802.11 client may be capable of storing a short client identifier in non-volatile memory. In some examples, if the AP 602 and the AMP device 604 are physically close (such as a smartphone and a key card), the client identification in the control frame 612 may be omitted.

As described herein, an AMP device 604 may have clock drift from 1000 ppm to 100000 ppm due to low complexity and low-cost implementation. The AMP device 604 may align the clock reference time of the AMP device 604 as closely as possible to the uplink start time for channel access 616. In some examples, the AMP device 604 may use the control frame 612 (or the end of the energizing signal 606 where the energizing signal 606 is the control frame) as a reference clock to determine the timing for the channel access 616. Accordingly, as the AMP device 604 may use the receive time of the control frame 612 that solicits the uplink access attempt as the reference time for the channel access 616, the AMP device 604 may not rely on a precise clock. Additionally, or alternatively, as the AMP device 604 may respond to the control frame 612 within an IFS duration (such as the duration 614 which may be a SIFS or PIFS duration) of reception of the control frame 612, which may be short duration of time, the clock drift during the duration 614 may be minimal and may not pose a timing problem. In some examples, the AMP device 604 may respond to the control frame 612 any duration T where T>=0. In some examples, the energizing signal 606 or the control frame 612 may include a timestamp (for example, the timing synchronization function (TSF)) from the AP 602, which the AMP device 604 may use to synchronize timing with the AP 602. Inclusion of a timestamp in the energizing signal 606 or the control frame 612 may result in additional overhead for the frames carrying the timestamp, and the timestamp may become outdated at the AMP device 604 due to clock drift.

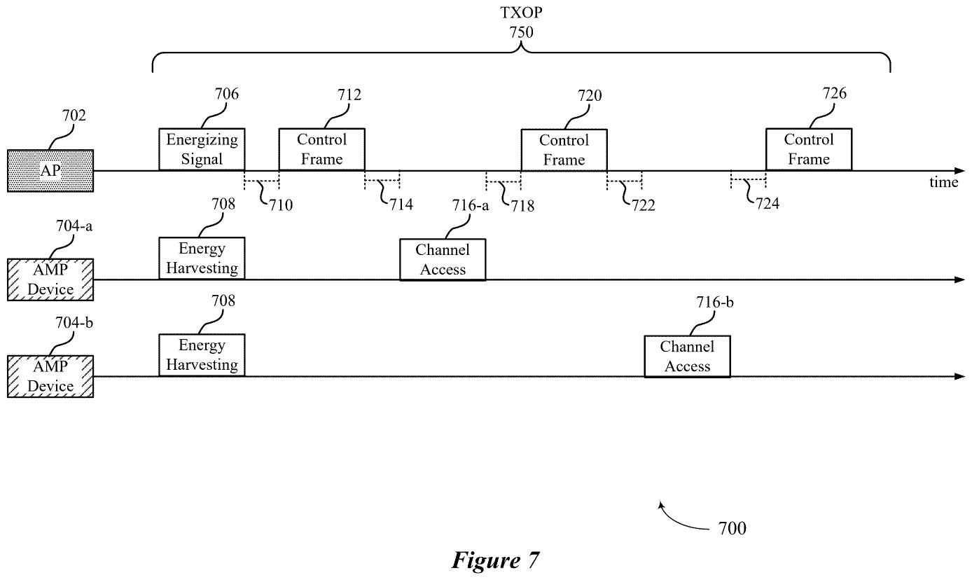

FIG. 7 shows an example of a timing diagram 700 that supports uplink access for AMP clients. The timing diagram 700 may implement or may be implemented by aspects of the wireless communication network 100, the wireless communication network 300, the signaling diagrams 400, or the AMP operation flow diagram 500. For example, the timing diagram 700 may illustrate communications in a unicast example between multiple AMP devices 704 (such as the AMP devices 404 of FIGS. 4A and 4B) and an AP 702 (such as an AP 102 as described with reference to FIGS. 1 and 3, a wireless communication device 402 as described with reference to FIG. 4A, or a wireless communication device 408 as described with reference to FIG. 4B).

For example, unicast communications involving multiple AMP devices 704 (such as the AMP device 704-a and the AMP device 704-b) may include multiple client active uplink communications per TXOP 750 using multiple control frames. The AMP devices 704 may perform energy harvesting 708 on an energizing signal 706 at the beginning of the TXOP 750.

A duration 710 after the energizing signal 706, the AP 702 may send a control frame 712 that solicits a response from the AMP device 704-a. For example, the control frame 712 may include an identifier for the AMP device 704-a (such as a MAC address or a short identifier). In some examples, the control frame 712 may be a PDU as described with reference to FIG. 2 or a PPDU as described herein. The AMP device 704-a may perform channel access 716-a a duration 714 (such as an IFS duration or any duration T where T>=0) after reception of the control frame 712 (for example, using the control frame 712 as a reference time) to perform an uplink transmission to the AP 702. A duration 718 (such as an IFS duration) after the channel access 716-a, the AP 702 may transmit a control frame 720 that solicits a response from the AMP device 704-b. For example, the control frame 712 may include an identifier for the AMP device 704-b (such as a MAC address or a short identifier). In some examples, the control frame 720 may also serve as an ACK for the AMP device 704-a for the uplink transmission transmitted in accordance with the channel access 716-a. In some examples, if no ACK is sent (for example, the uplink transmission transmitted in accordance with the channel access 716-a failed), the control frame 720 may be unicast to the AMP device 704-b. In some examples, the control frame 720 may include other information associated with the AMP device 704-a. In some examples, the AP 702 may send an ACK to the AMP device 704-a which is separated from the control frame 720 by an IFS duration, but such separate signaling may consume more air time. The AMP device 704-b may perform channel access 716-b a duration 722 (such as an IFS duration or any duration T where T>=0) after reception of the control frame 720 (for example, using the control frame 720 as a reference time) to perform an uplink transmission to the AP 702. A duration 724 (such as an IFS duration) after the channel access 716-b, the AP 702 may transmit a control frame 726. The control frame 726 may solicit a response from another AMP device, may provide an ACK to the AMP device 704-b for the uplink transmission transmitted in accordance with the channel access 716-b, and/or may provide other information to the AMP device 704-b.

When communicating with multiple AMP devices 704 during a TXOP 750, the AP 702 may determine the order of the channel accesses 716 of the AMP devices 704 based on the capabilities of the AMP devices 704 known to the AP 702. For example, AMP devices 704 with similar capabilities may be scheduled in a random order. As another example, AMP devices 704 with a smaller amount of harvested energy may be scheduled earlier in the TXOP 750. For example, the energy harvesting or storage capabilities of the AMP devices 704 may be reported during the first phase 502 (offline onboarding), the second phase 504 (initial information exchange), or the third phase 506 (the AMP operation mode information exchange), and the AP 702 may schedule the AMP devices with capabilities to harvest more energy later in the TXOP 750. As another example, the AMP devices 704 may report stored energy levels in the second phase 504 (initial information exchange) or the third phase 506 (the AMP operation mode information exchange), and the AP 702 may schedule AMP devices with more stored energy later in the TXOP 750. As another example, the AP 702 may schedule AMP devices of the same device type (for example, determined in the first phase 502 or the second phase 504). As another example, the order may depend on the type of uplink data reported by the AMP devices 704. For example, AMP devices 704 with similar data to be reported may send data close to each other (such as the prices of similar appliances in a warehouse). For example, what type of data each AMP device includes may be determined by the AP 702 based on device information exchanged during the first phase 502 (offline onboarding) or the second phase 504 (initial information exchange). As another example, the AP 702 may determine that AMP devices 704 with identifiers within given ranges has similar or the same type of data to report. As another example, the AP 702 may schedule the AMP devices with higher clock drifts earlier in the TXOP. For example, the clock drift of an AMP device may be indicated in one or more of the first phase 502, the second phase 504, or the third phase 506 as described herein. As another example, the AP 702 may determine the clock drift of an AMP device based on the device type of the AMP device.

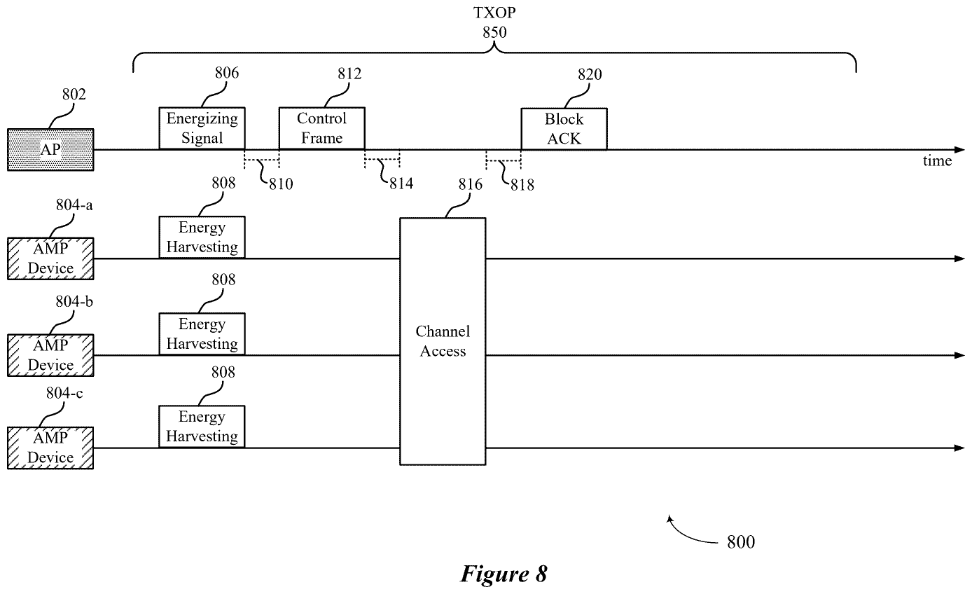

FIG. 8 shows an example of a timing diagram 800 that supports uplink access for AMP clients. The timing diagram 800 may implement or may be implemented by aspects of the wireless communication network 100, the wireless communication network 300, the signaling diagrams 400, or the AMP operation flow diagram 500. For example, the timing diagram 800 may illustrate communications in a broadcast or multicast example between multiple AMP devices 804 (such as the AMP devices 404 of FIG. 4) and an AP 802 (such as an AP 102 as described with reference to FIGS. 1 and 3, a wireless communication device 402 as described with reference to FIG. 4A, or a wireless communication device 408 as described with reference to FIG. 4B).

For example, broadcast or multicast communications involving multiple AMP devices 804 (such as the AMP device 804-a, the AMP device 804-b, and the AMP device 804-c) may include multiple client active uplink communications per TXOP 850 using a single control frame (the control frame 812). The AMP devices 804 may perform energy harvesting 808 on an energizing signal 806 at the beginning of the TXOP 850. For example, broadcast or multicast communications involving multiple AMP devices 804 may be used to solicit responses from the multiple AMP clients, such as reading a list of items or goods in a warehouse. Broadcast or multicast communications may be similar to unicast communications, with some broadcast or multicast related adjustments to the content of the control frame 812. In some examples, the energizing signal 806 may be combined with the control frame 812, similarly to unicast communications with reference to FIGS. 6 and 7. In some examples, the control frame 812 may be a PDU as described with reference to FIG. 2 or a PPDU as described herein.

In some examples, the AP 802 may send the control frame a duration 810 (such as an IFS duration) after the energizing signal 806. In response to the control frame 812, the AMP devices 804 may perform channel access 816 to perform respective uplink transmissions. The AMP devices 804 may perform channel access at least a duration 814 (such as an IFS duration or any duration T where T>=0) after the control frame 812. For example, channel access may be a type of multiple access such as TDMA, CDMA, FDMA, or OFDMA. The AP 802 may send feedback, such as via a Block ACK 820 to the AMP devices 804 for the uplink transmissions, at least a duration 818 after the channel access 816 (for example, after the resources used for the channel access 816).

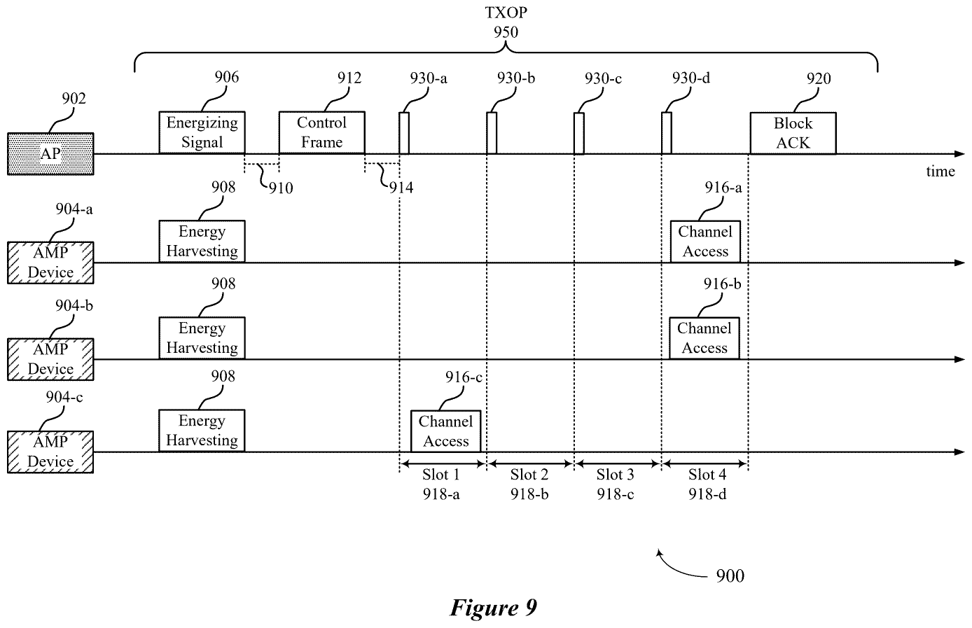

FIG. 9 shows an example of a timing diagram 900 that supports uplink access for AMP clients. The timing diagram 900 may implement or may be implemented by aspects of the wireless communication network 100, the wireless communication network 300, the signaling diagrams 400, the AMP operation flow diagram 500, or the timing diagram 800. For example, the timing diagram 900 may illustrate communications in a broadcast or multicast example between multiple AMP devices 904 (such as the AMP devices 404 of FIGS. 4A and 4B) and an AP 902 (such as an AP 102 as described with reference to FIGS. 1 and 3, a wireless communication device 402 as described with reference to FIG. 4A, or a wireless communication device 408 as described with reference to FIG. 4B).

For example, broadcast or multicast communications involving multiple AMP devices 904 (such as the AMP device 904-a, the AMP device 904-b, and the AMP device 904-c) may include multiple client active uplink communications per TXOP 950 using a single control frame (the control frame 912). The AMP devices 904 may perform energy harvesting 908 on an energizing signal 906 at the beginning of the TXOP 950. In some examples, the AMP devices 904 may perform random access in time in response to the control frame 912 to access the channel and perform the solicited uplink communications. In some examples, the AP 902 may send the control frame 912 a duration 910 (such as an IFS duration) after the energizing signal 906. In some examples, the control frame 912 may be a PDU as described with reference to FIG. 2 or a PPDU as described herein.

For example, after receiving the control frame 912 the AMP devices 904 may randomly select a slot 918 from the slot range 1, . . . , n provided by the AP (for example, a version of slotted ALOHA or ALOHAnet). For example, as shown, the control frame 912 may indicate 4 slots (slot 918-a, slot 918-b, slot 918-c, and slot 918-d) available for channel access 916. The temporally first slot available for channel access 916 (the slot 918-a) may be a duration 914 (such as an IFS duration or any duration T where T>=0) after the control frame 912. The AMP devices 904 may determine the start times of the slots 918 based on the received time of the control frame 912 (for example, may use the received time of the control frame as a reference time to account for clock drift at the AMP devices 904).

Due to random selection of slots 918, there may be slots that are empty (for example, in which no AMP devices 904 perform channel access 916) and slots in which a collision occurs (for example, where multiple AMP devices perform channel access 916). For example, in the slot 918-a, the AMP device 904-c may perform channel access 916-c. In the slot 918-b and the slot 918-c, no AMP device 904 may perform channel access (thus, the slot 918-b and the slot 918-c may be empty). In the slot 918-d, the AMP device 904-a may perform channel access 916-a and the AMP device 904-b may perform channel access 916-b, and accordingly a collision may occur in the slot 918-d. The AP 902 may provide feedback for the uplink transmissions in the slots 918 (for example, using a Block ACK 920).

As shown in the timing diagram 900, the slot 918-b and the slot 918-c may be empty, in which case a neighboring device may attempt to gain control of the medium. To avoid another device gaining control of the medium, the AP 902 may take control of the channel medium back, for example, via a PIFS recovery. In some examples, the AP 902 may use an empty slot to broadcast an energizing signal until the start of the next slot, which may keep the medium busy and may provide energy to AMP devices waiting for their selected slot. In some examples, if the AP 902 observes frequent empty slots, the AP 902 may reduce the quantity of slots available in subsequent TXOPs, in an attempt to match the quantity of AMP devices, which may improve medium utilization.

In some examples, if a collision occurs (for example, as shown in slot 918-d), if the AP 902 cannot receive any meaningful data from any of the collided uplink responses, the AP 902 may solicit responses from the collided AMP devices in the same TXOP or in subsequent TXOPs. For example, if the AP 902 knows which AMP devices collided (for example, if the AP 902 solicited responses from specific AMP devices 904 using the MAC addresses or client identifiers for the AMP devices 904). In examples where the control frame 912 is broadcast (or where the energizing signal 906 which is also the control frame is broadcast), the AP 902 may not be able to determine which AMP devices 904 collided. In such examples, the AP 902 may continue to solicit responses from the AMP devices 904 using broadcast control frames. In some examples, if the AP 902 observes frequent collisions in slots 918, the AP 902 may increase the quantity of slots in subsequent TXOPs (for example, within a TXOP limit) in an attempt to match the quantity of AMP devices 904 to improve the medium utilization. In some examples, if the AP 902 observes frequent collisions in slots 918, the AP 902 may reduce the quantity of AMP devices solicited in a TXOP (for example, for multicast solicited responses) to improve the medium utilization.

As described herein, the AMP devices 904 may use the receive time of either the energizing signal 906 or the control frame 912 as a reference time for transmissions within the TXOP 950. Clock drift may disrupt multiple access in the TXOP 950 by causing the uplink transmission from one slot 918 to overspill into a neighboring slot. For example, in a 2 millisecond (ms) multiple access scenario with a 10000 ppm clock drift, AMP devices may experience a 10 to 20 microsecond (μs) of clock drift, which may lead to partial collisions of adjacent uplink responses, particularly in slots farther from the clock reference time towards the end of the TXOP (such as overspilling of a transmission in slot 918-c into slot 918-d). Overspilling into subsequent slots may worsen with higher clock drifts, such as 100000 ppm in some backscatter AMP devices.

In some examples, to mitigate the effect of overspilling due to clock drift, guard intervals may be positioned between neighboring slots. For example, a first guard interval may separate the slot 918-a and the slot 918-b, a second guard interval may separate the slot 918-b and the slot 918-c, and a third guard interval may separate the slot 918-c and the slot 918-d. The guard interval may account for expected clock drift and may be large enough to accommodate the maximum drift during the TXOP (such as 20 μs of guard interval in 2 ms of multiple access with a 10000 ppm clock drift).

In some examples, to mitigate the effect of overspilling due to clock drift, the AP 902 may transmit a start or synchronization signal 930 at the beginning of each slot 918 (for example, a start signal 930-a in the slot 918-a, a start signal 930-b in the slot 918-b, a start signal 930-c in the slot 918-c, and a start signal 930-d in the slot 918-d). An AMP device 904 that has selected the slot 918 may begin its uplink transmission after reception of the ‘start’ or synchronization signal from the AP 902. The start signals 930 may be short energizing signals or control/poll frames to synchronize the slot start with the AMP devices 904. If the AP 902 provides an ACK for each slot 918 (for example, per uplink resource), the start signal 930 may serve as both an ACK for the prior slot and the start/synchronization signal for the slot.

In some examples, each AMP device 904 may randomly select a resource (for example, a slot 918) from the set of candidate resources (for example, from the set of slots 918) indicated in the control frame 912. In some examples, slotted ALOHA may be modified such that each AMP device may access a slot with an access probability p. An AMP device 904 may skip a slot 918 with a probability of 1-p and may attempt to access the temporally next slot with a probability p, continuing until the AMP device 904 accesses the medium. The probability p may be indicated to the AMP devices 904 in the energizing signal 906 or the control frame 912 for the TXOP 950 or during the first phase 502, the second phase 504, the third phase 506, or any combination thereof. In some examples, the probability p may be hard coded in the AMP device 904. In such examples, empty slots may still occur if no AMP device 904 accesses the medium in a given slot, collisions may still occur if multiple AMP devices 904 access the medium in a given slot, and clock drift may still occur. The AP 902 may adapt the probability p to reduce empty slots and/or to reduce collisions based on the quantity of empty slots and collisions observed in previous TXOPs. During each TXOP, the AP 902 may indicate the probability p via the energizing signal 906 and/or the control frame 912. For example, if the AP 902 observes too many empty slots, the AP 902 may instruct the AMP devices 904 to access with a higher (increased as compared to previous) probability p, and vice versa. Similarly, if the AP 902 observes too many collisions, the AP 902 may may instruct the AMP devices 904 to access with lower (decreased as compared to previous) probability p, and vice versa. Accordingly, the AP 902 may increase or decrease the access probability p and/or may increase or decrease the quantity of slots 918 based on the observed quantity of empty slots and/or collisions.

As described herein, in examples of multicast or broadcast control frames soliciting responses, the AMP device 904 may use random access in time to respond, which may result in collisions. In some examples, the AP 902 may first poll AMP devices 904 (for example, using a control frame 912 as described herein) asking which AMP devices 904 are available, and the AMP devices 904 may respond with their respective identifiers (for example, MAC addresses or client identifiers) using random access in time (for example, slotted ALOHA). Accordingly, collisions may occur during the discovery/polling phase. Based on unambiguous responses from the discovery/polling phase, (for example, the AMP devices 904 without collisions), the AP 902 may send a control/poll frame to deterministically schedule AMP devices 904 for uplink transmissions in specific slots using IDs to avoid collisions (for example, may use unicast signaling to schedule uplink access for specific AMP devices 904). For example, the call flow may be as follows: the AP 902 may poll four AMP devices 904 and may provide four slots to provide their identifiers; the AMP devices 904 may select the slots (for example, either randomly or with a given probability p); and the AP 902 may schedule the AMP devices 904 from the four AMP devices from which the AP 902 receives clear responses deterministically in slots using another control frame. For example, in the discovery/polling phase, if AMP device #2 and #4 select the same slot, but the AP 902 receives clear responses from AMP devices #1 and #3, the AP 902 may schedule the AMP devices #1 and #3 deterministically using a control frame in two slots (for example, AMP device #1 in slot 1 and AMP device #3 in slot 2).

In some examples, where the AMP devices 904 perform random access for uplink responses solicited by the control frame 912, the AP 902 may provide ACK feedback for the uplink responses. In some examples, the ACK may be an aggregated ACK at the end of reception of the uplink responses (for example, a Block ACK 920 as shown). In some examples, the AP 902 may provide an ACK for each uplink response within each slot 918. In some examples, as described herein, the ACK for each slot may serve as the start signal 930 for the next slot. In some examples, the AP 902 may not provide an ACK, for example, for data that may not demand an ACK, such as a temperature reading from an AMP device 904. If no ACK is provided, and the AP 902 does not receive an expected uplink response (for example, due to a collision), the AP 902 may reattempt to solicit the data from the AMP device 904.

In multicast scenarios, the AP 902 may identify AMP devices 904 using their MAC addresses in the control frame 912 and/or another identifier for the AMP devices 904 (such as a short identifier) known to the AP 902 beforehand. In some examples, the AP 902 may use a group identifier assigned to a set of AMP devices when requesting data from that group of AMP devices. In broadcast scenarios, the AP may provide energy for a given duration (for example, via the energizing signal 906) and may broadcast the control frame 912. Whichever AMP devices 904 wake up from the energizing signal 906 and receive the control frame 912 may attempt to access the channel (for example, may perform channel access 916) using random access as described herein. In some examples, the energizing signal 906 and the control frame 912 may be combined, as described herein. For example, the AP 902 may provide energy, and AMP devices 904 with sufficient energy may wait and select a random slot, with the slot range either hard coded or indicated in the energizing signal 906.

In some examples, random access may be performed in the frequency domain (for example, instead of or in addition to in the time domain). For example, AMP devices may select a frequency band in which to perform channel access 916 from a set of multiple frequency bands that divide the allocated frequency spectrum. The set of multiple frequency bands may be indicated in the control frame 912 or the energizing signal 906 where the energizing signal 906 is combined with the control frame. A frequency band may be treated similarly to a slot 918 in slotted ALOHA. The AP 902 may use either static or dynamic division of the frequency spectrum in multiple frequency bands (for example, narrow frequency bands). For example, the quantity of frequency bands may depend on the quantity of estimated clients, the quantity of empty frequency bands observed in prior TXOPs, and/or the quantity of collisions observed in prior TXOPs. The division of frequency bands may be performed in an AFDMA manner, where AMP devices 904 select RUs randomly or the AP 902 may assign specific RUs. In some examples, the energizing signal 906 may span the frequency spectrum of the AP 902 that will be used for multiple access so that AMP devices 904 in all of the frequency bands used for random access may receive the energizing signal 906. The control frame 912 may be duplicated in each frequency band that will be used for multiple access so that AMP devices 904 in all of the frequency bands used for random access may receive the control frame 912. The random access in frequency may be combined with random access in time (for example, an AMP device 904 may select a random frequency band from a set of multiple frequency bands and may select a random slot from a set of multiple slots in the selected frequency band).

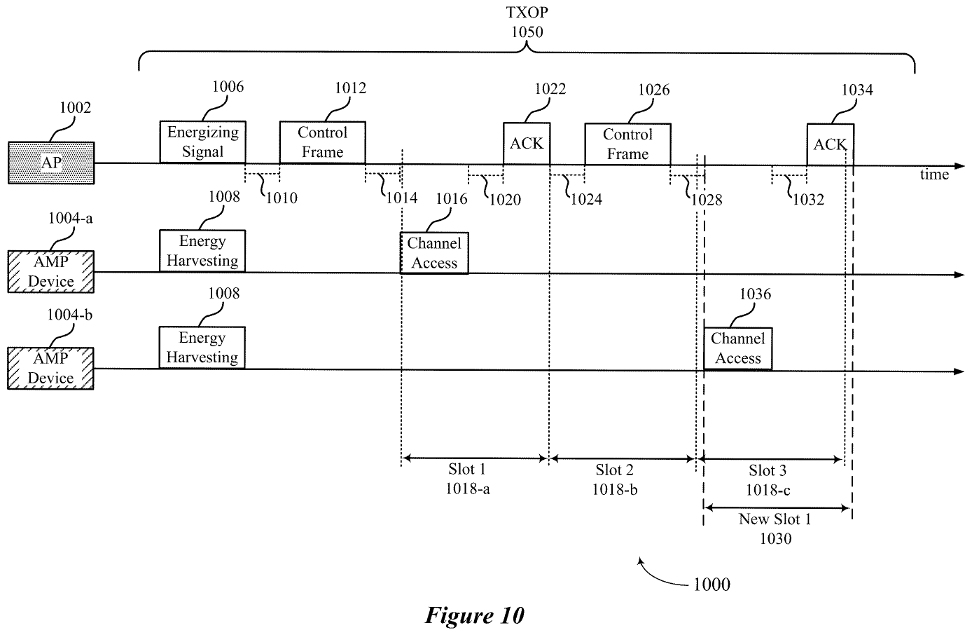

FIG. 10 shows an example of a timing diagram 1000 that supports uplink access for AMP clients. The timing diagram 1000 may implement or may be implemented by aspects of the wireless communication network 100, the wireless communication network 300, the signaling diagrams 400, the AMP operation flow diagram 500, or the timing diagram 900. For example, the timing diagram 1000 may illustrate communications in a broadcast or multicast example between multiple AMP devices 1004 (such as the AMP devices 404 of FIGS. 4A and 4B) and an AP 1002 (such as an AP 102 as described with reference to FIGS. 1 and 3, a wireless communication device 402 as described with reference to FIG. 4A, or a wireless communication device 408 as described with reference to FIG. 4B).

For example, broadcast or multicast communications involving multiple AMP devices 1004 (such as the AMP device 1004-a and the AMP device 1004-b) may include multiple client active uplink communications per TXOP 1050 using a single control frame (the control frame 1012). The AMP devices 1004 may perform energy harvesting 1008 on an energizing signal 1006 at the beginning of the TXOP 1050. In some examples, the AMP devices 904 may perform random access in time in response to the control frame 1012 to access the channel and perform the solicited uplink communications. In some examples, the AP 1002 may send the control frame 1012 a duration 1010 (such as an IFS duration) after the energizing signal 1006). In some examples, the control frame 1012 may be a PDU as described with reference to FIG. 2 or a PPDU as described herein.

For example, after receiving the control frame 1012 the AMP devices 1004 may randomly select a slot 1018 from the slot range 1, . . . , n provided by the AP 1002 (for example, a version of slotted ALOHA). For example, as shown, the control frame 1012 may indicate 3 slots (slot 1018-a, slot 1018-b, and slot 1018-c) available for channel access 1016. The temporally first slot available for channel access 1016 (the slot 1018-a) may be a duration 1014 (such as an IFS duration or any duration T where T>=0) after the control frame 1012. The AMP devices 1004 may determine the start times of the slots 1018 based on the received time of the control frame 1012 (for example, may use the received time of the control frame as a reference time to account for clock drift at the AMP devices 1004). The AMP device 1004-a may select the slot 1018-a and may perform channel access 1016 to transmit a response to the control frame 1012. A duration 1020 (such as an IFS duration) after the channel access 1016, the AP 1002 may transmit an ACK 1022 for the response transmitting via performance of the channel access 1016.

No AMP device 1004 may perform channel access in the slot 1018-b, and thus the AP 1002 may perform a PIFS recovery and send a second control frame 1026 during the slot 1018-b to regain control of the medium and restart the slotted ALOHA. The AP 1002 may send the second control frame 1026 a duration 1024 (such as an IFS duration) after the start of the slot 1018-b. The second control frame 1026 may be used as a new reference time by the AMP devices. For example, a timing of a new slot 1030 for random access may be a duration 1028 after the second control frame 1026. The AMP device 1004-b may select the new slot 1030 and may perform channel access 1036 to transmit a response to the second control frame 1026. A duration 1032 (such as an IFS duration) after the channel access 1036, the AP 1002 may transmit an ACK 1034 for the response transmitting via performance of the channel access 1036.

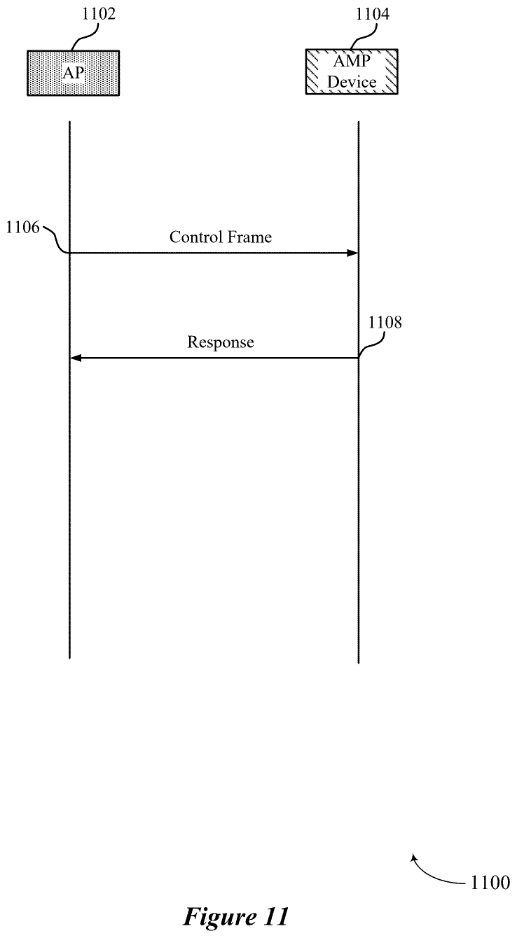

FIG. 11 shows an example of a process flow 1100 that supports uplink access for AMP clients. The process flow 1100 may implement or may be implemented by aspects of the of the wireless communication network 100, the wireless communication network 300, the signaling diagrams 400, the AMP operation flow diagram 500, the timing diagram 600, the timing diagram 700, the timing diagram 800, the timing diagram 900, or the timing diagram 1000. The process flow 1100 includes an AP 1102 (such as an AP 102 as described with reference to FIGS. 1 and 3, a wireless communication device 402 as described with reference to FIG. 4A, a wireless communication device 408 as described with reference to FIG. 4B, an AP 602 as described with reference to FIG. 6, an AP 702 as described with reference to FIG. 7, an AP 802 as described with reference to FIG. 8, an AP 902 as described with reference to FIG. 9, or an AP 1002 as described with reference to FIG. 10) and an AMP device 904 (such as the AMP devices 404 of FIGS. 4A and 4B, the AMP devices 604 of FIG. 6, the AMP devices 704 of FIG. 7, the AMP devices 804 of FIG. 8, the AMP devices 904 of FIG. 9, or the AMP devices 1004 of FIG. 10). In the following description of the process flow 1100, the communications between the AP 1102 and the AMP device 1104 may be transmitted in a different order than the example order shown, or the operations performed by the AP 1102 and the AMP device 1104 may be performed in different orders or at different times. Some operations also may be omitted from the process flow 1100, and other operations may be added to the process flow 1100.

At 1106, the AP 1102 may transmit, and the AMP device 1104 may receive, a control frame that solicits a response from the AMP device 1104. The control frame may be indicative of one or more resources associated with uplink access for the response in a shared medium subject to carrier sense type channel access.

At 1108, the AMP device 1104 may perform uplink access based on the control frame to transmit the response to the AP 1102.

In some examples, the AP 1102 may transmit an energizing signal to the AMP client device (for example, prior to the one or more resources). In some examples, the AP 1102 may transmit an indication to an energizing device to provide an energizing signal to the AMP device 1104 prior to the one or more resources. The AMP device 1104 may harvest energy from the energizing signal and may use the harvested energy to transmit the response.

In some examples, the control frame may be a unicast control frame that includes an identifier associated with the AMP client device. In some examples, the control frame may be indicative of the one or more resources being an interframe space duration (for example, an IFS duration) or any duration T where T>=0 after the control frame based on the control frame being the unicast control frame.

In some examples, the AP 1102 may transmit, via the control frame or a second control frame, a solicitation of a second response from a second AMP device, and the control frame or the second control frame may be indicative of a time resource for the second response.

In some examples, a receive time of the control frame at the AMP client device may be reference time with respect to the one or more resources.

In some examples, the AP 1102 may transmit, within a same TXOP as the control frame, a second control frame that solicits a second response from a second AMP device. The control frame may be indicative of one or more second resources associated with uplink access for the second response, and the second control frame may include information associated with the AMP device 1104 or the second AMP device. For example, the information may include ACK feedback for the response at 1108 and/or scheduling information for the second AMP device. In some such examples, the AP 1102 may receive, based on the second control frame, the second response from the second AMP client device. In some examples, the AP 1102 may transmit, within the same TXOP, third control frame that includes second information associated with the second AMP device and/or a third AMP device. For example, the second information may include ACK feedback for the second response and/or scheduling information for the third AMP device.

In some examples, the AP 1102 may broadcast or multicast the control frame at 1106. In some such examples, the one or more resources may include a set of resources indicated by the control frame as available for uplink random access. The AP 1102 may monitor for responses from AMP devices in the set of resources. The response at 1108 may be received in a resource of the set of resources based on the monitoring. In some examples, the AMP device 1104 may randomly select the resource from the set of resources. In some examples, the AMP device 1104 may select the resource from the set of resources in accordance with respective access probabilities for each resource of the set of resources. In some examples, the AMP device 1104 may receive, from the AP 1102 via the control frame or an energizing signal associated with a TXOP that includes the set of resources, an indication of the respective access probabilities.

In some examples, the AP 1102 may perform an interframe space recovery (for example, a PIFS recovery) in a second slot of the set of resources based on an absence of a second response during the second slot to regain control of the medium. In some examples, if the AP 1102 does not receive the response in the expected slot at 1108, the AP 1102 may perform an interframe space recovery (for example, a PIFS recovery) to regain control of the medium.

In some examples, the AP 1102 may receive a second response from a second AMP device in a same slot of the set of resources as the response, where the control frame is a broadcast control frame. In some such examples, the AP 1102 may broadcast a second version of the control frame based on reception of the response and the second response in the same slot, where the second version of the control frame is indicative of one or more second resources associated with uplink access for responses to the second version of the control frame.

In some examples, the AP 1102 may receive a second response from a second AMP device in a same slot of the set of resources as the response, where the control frame is a multicast control frame that includes a first identifier associated with the AMP device 1104 and a second identifier associated with the second AMP device. In some such examples, the AP 1102 may transmit one or more second control frames that solicit a first retransmission of the response from the AMP device 1104 and a second retransmission of the second response from the second AMP device.

In some examples, the AP 1102 may transmit a synchronization signal (such as a start signal 930) at a respective beginning of each slot of the set of resources.

In some examples, the AP 1102 may receive a set of responses from a set of AMP devices via the set of resources, and the AP 1102 may transmit respective ACKs for the set of responses respective interframe space durations after the set of responses.

In some examples, the AP 1102 may transmit a second control frame that solicits a second response from the AMP device 1104 based on the response. For example, the response may indicate an identifier associated with the AMP client device. For example, the control frame may be a broadcast control frame during a discovery phase. The control frame may be indicative of a second resource associated with uplink access for the second response, and the second control frame may include the identifier associated with the AMP device 1104.

In some examples, the AP 1102 may transmit a block ACK feedback for a set of responses received via the set of resources, where the set of responses includes the response.

In some examples, the set of resources are a set of slots. In some examples, the set of resources are a set of frequency resources in a same slot.

In some examples, the AMP device 1104 may be a backscatter device. For example, the AP 1102 may transmit an interrogating signal during the one or more resources, and the response at 1108 may be a backscatter response. For example, backscatter AMP devices may perform uplink access by modulating and reflecting existing radio frequency signals (as compared to generating their own signals). For example, uplink access for a backscatter AMP device may involve: transmission by the AP 1102 of an energizing signal and/or the control frame at 1106 that provides a range of time slots or frequency bands. The AP 1102 may continue sending carrier signals (also referred to as interrogating signals) for backscatter AMP devices to reflect and modulate uplink data. After reception of the control frame, the backscatter AMP devices may set the reference clock time based on the reception of the control frame. The backscatter AMP devices may randomly select respective resources (slots and/or frequency bands) for modulation of uplink data, and may modulate uplink data onto the reflected carrier signal during the selected resource. APs may use more frequent start signals or synchronization signals for backscatter AMP devices as clock drift for backscatter AMP devices may reach 100000 ppm (in other words, 10% clock drift).

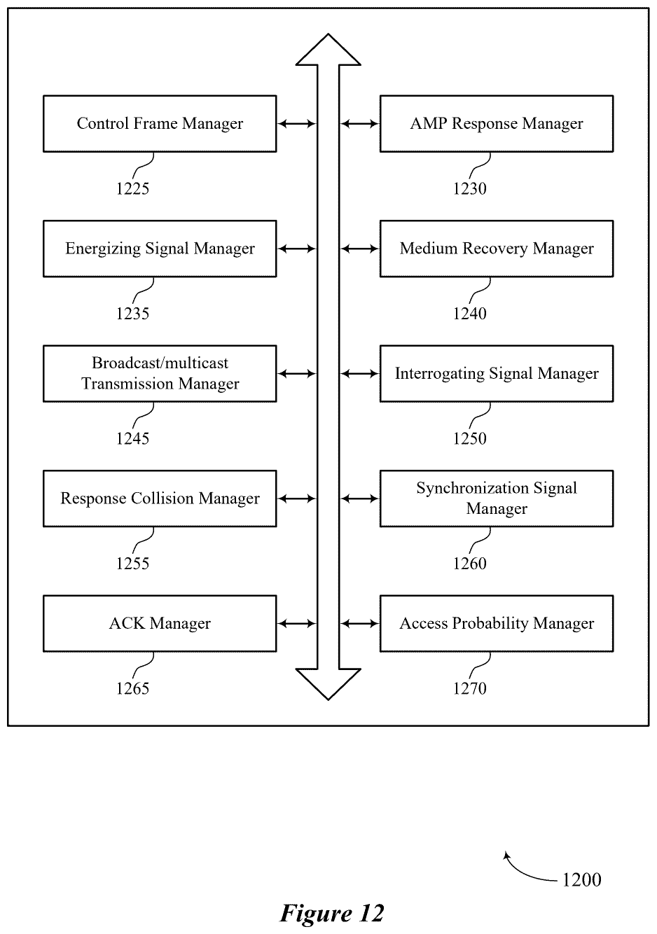

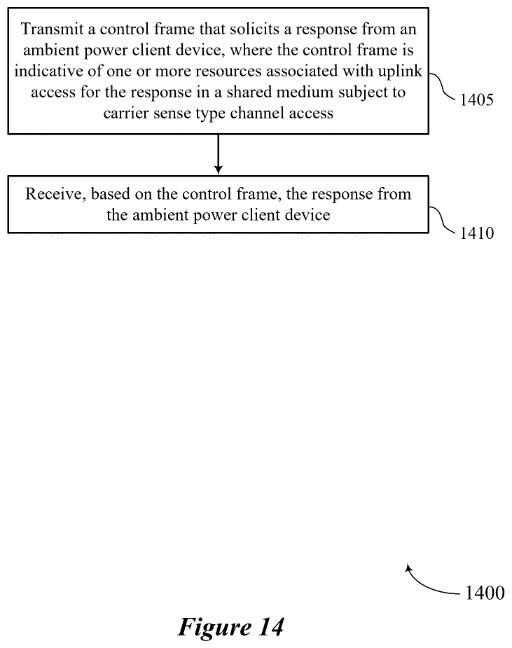

FIG. 12 shows a block diagram of an example wireless communication device 1200 that supports uplink access for AMP clients. In some examples, the wireless communication device 1200 is configured to perform the process 1400 described with reference to FIG. 14. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP, such as the AP 102 described with reference to FIG. 1. In some other examples, the wireless communication device 1200 can be an AP that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a control frame manager 1225, an AMP response manager 1230, an energizing signal manager 1235, a medium recovery manager 1240, a broadcast/multicast transmission manager 1245, an interrogating signal manager 1250, a response collision manager 1255, a synchronization signal manager 1260, an ACK manager 1265, and an access probability manager 1270. Portions of one or more of the control frame manager 1225, the AMP response manager 1230, the energizing signal manager 1235, the medium recovery manager 1240, the broadcast/multicast transmission manager 1245, the interrogating signal manager 1250, the response collision manager 1255, the synchronization signal manager 1260, the ACK manager 1265, and the access probability manager 1270 may be implemented at least in part in hardware or firmware. For example, one or more of the control frame manager 1225, the AMP response manager 1230, the energizing signal manager 1235, the medium recovery manager 1240, the broadcast/multicast transmission manager 1245, the interrogating signal manager 1250, the response collision manager 1255, the synchronization signal manager 1260, the ACK manager 1265, and the access probability manager 1270 may be implemented at least in part by at least a processor or a modem. In some examples, portions of one or more of the control frame manager 1225, the AMP response manager 1230, the energizing signal manager 1235, the medium recovery manager 1240, the broadcast/multicast transmission manager 1245, the interrogating signal manager 1250, the response collision manager 1255, the synchronization signal manager 1260, the ACK manager 1265, and the access probability manager 1270 may be implemented at least in part by a processor and software in the form of processor-executable code stored in memory.

The wireless communication device 1200 may support wireless communications in accordance with examples as disclosed herein. The control frame manager 1225 is configurable or configured to transmit a control frame that solicits a response from an AMP client device, where the control frame is indicative of one or more resources associated with uplink access for the response in a shared medium subject to carrier sense type channel access. The AMP response manager 1230 is configurable or configured to receive, based on the control frame, the response from the AMP client device.

In some examples, the energizing signal manager 1235 is configurable or configured to transmit an energizing signal to the AMP client device, where reception of the response is based on transmission of the energizing signal.

In some examples, the energizing signal manager 1235 is configurable or configured to transmit an indication to an energizing device to provide an energizing signal to the AMP client device prior to the one or more resources.

In some examples, the control frame includes a unicast control frame including an identifier associated with the AMP client device. In some examples, the control frame is indicative of the one or more resources being an interframe space duration after the control frame based on the control frame being the unicast control frame.

In some examples, the control frame manager 1225 is configurable or configured to transmit, via the control frame or a second control frame, a solicitation of a second response from a second AMP client device, where the control frame or the second control frame is indicative of a time resource for the second response. In some examples, the medium recovery manager 1240 is configurable or configured to perform a interframe space recovery based on an absence of the second response during the time resource.

In some examples, a receive time of the control frame at the AMP client device includes a reference time with respect to the one or more resources.

In some examples, the control frame manager 1225 is configurable or configured to transmit, within a same TXOP as the control frame, a second control frame that solicits a second response from a second AMP client device, where the control frame is indicative of one or more second resources associated with uplink access for the second response, and where the second control frame includes information associated with the AMP client device or the second AMP client device. In some examples, the AMP response manager 1230 is configurable or configured to receive, based on the second control frame, the second response from the second AMP client device. In some examples, the control frame manager 1225 is configurable or configured to transmit, within the same TXOP, a third control frame that includes second information associated with the second AMP client device or a third AMP device.

In some examples, to support transmitting the control frame, the broadcast/multicast transmission manager 1245 is configurable or configured to broadcast or multicast the control frame, where the one or more resources include a set of resources indicated by the control frame as available for uplink random access, the method further including monitoring for responses from AMP client devices in the set of resources, the response received in a resource of the set of resources based on the monitoring.

In some examples, the medium recovery manager 1240 is configurable or configured to perform a interframe space recovery in a second slot of the set of resources based on an absence of a second response during the second slot.

In some examples, the response collision manager 1255 is configurable or configured to receive a second response from a second AMP client device in a same slot of the set of resources as the response, where the control frame is a broadcast control frame. In some examples, the response collision manager 1255 is configurable or configured to broadcast a second version of the control frame based on reception of the response and the second response in the same slot, where the second version of the control frame is indicative of one or more second resources associated with uplink access for responses to the second version of the control frame.

In some examples, the response collision manager 1255 is configurable or configured to receive a second response from a second AMP client device in a same slot of the set of resources as the response, where the control frame is a multicast control frame that includes a first identifier associated with the AMP client device and a second identifier associated with the second AMP client device. In some examples, the response collision manager 1255 is configurable or configured to transmit one or more second control frames that solicit a first retransmission of the response from the AMP client device and a second retransmission of the second response from the second AMP client device.

In some examples, the synchronization signal manager 1260 is configurable or configured to transmit a synchronization signal at a respective beginning of each slot of the set of resources.

In some examples, the AMP response manager 1230 is configurable or configured to receive a set of responses from a set of AMP client devices via the set of resources. In some examples, the ACK manager 1265 is configurable or configured to transmit respective ACKs for the set of responses respective interframe space durations after the set of responses.

In some examples, the access probability manager 1270 is configurable or configured to transmit, via the control frame or an energizing signal associated with a TXOP that includes the set of resources, an indication of a respective access probability for each resource of the set of resources.

In some examples, the control frame manager 1225 is configurable or configured to transmit a second control frame that solicits a second response from the AMP client device based on the response, where the response indicates an identifier associated with the AMP client device, where the second control frame is indicative of a second resource associated with uplink access for the second response, and where the second control frame includes the identifier associated with the AMP client device.

In some examples, the ACK manager 1265 is configurable or configured to transmit a block ACK feedback for a set of responses received via the set of resources, where the set of responses includes the response.

In some examples, the set of resources are a set of slots.

In some examples, the set of resources are a set of frequency resources in a same slot.

In some examples, the interrogating signal manager 1250 is configurable or configured to transmit an interrogating signal during the one or more resources, where the response is a backscatter response.

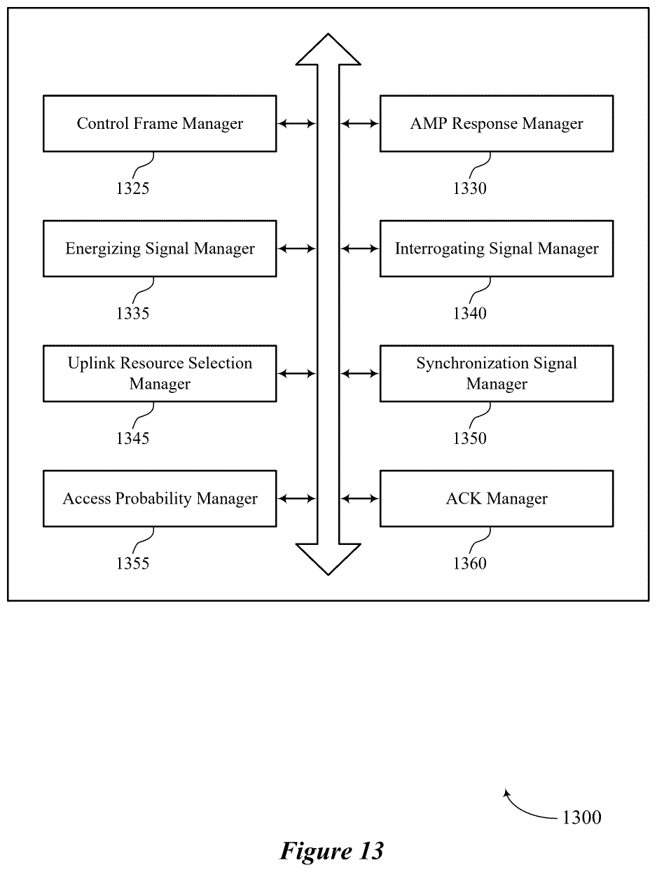

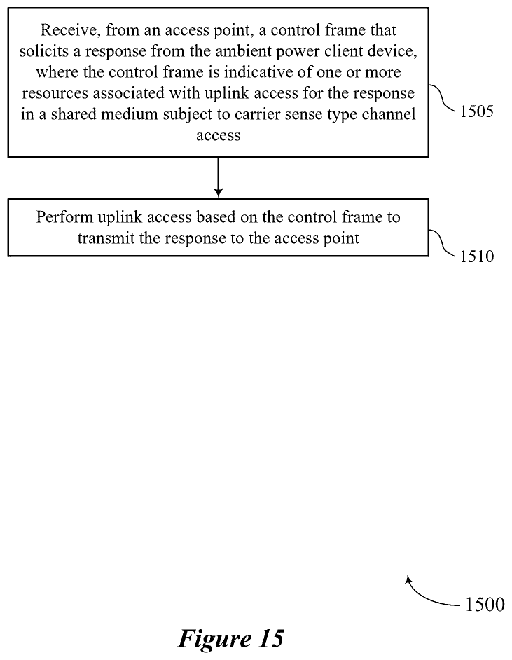

FIG. 13 shows a block diagram of an example wireless communication device 1300 that supports uplink access for AMP clients. In some examples, the wireless communication device 1300 is configured to perform the process 1500 described with reference to FIG. 15. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in a STA, such as the STA 104 described with reference to FIG. 1. In some other examples, the wireless communication device 1300 can be a STA that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes a user interface (UI) (such as a touchscreen or keypad) and a display, which may be integrated with the UI to form a touchscreen display that is coupled with the processing system. In some examples, the wireless communication device 1300 may further include one or more sensors such as, for example, one or more inertial sensors, accelerometers, temperature sensors, pressure sensors, or altitude sensors, that are coupled with the processing system.

The wireless communication device 1300 includes a control frame manager 1325, an AMP response manager 1330, an energizing signal manager 1335, an interrogating signal manager 1340, an uplink resource selection manager 1345, a synchronization signal manager 1350, an access probability manager 1355, and an ACK manager 1360. Portions of one or more of the control frame manager 1325, the AMP response manager 1330, the energizing signal manager 1335, the interrogating signal manager 1340, the uplink resource selection manager 1345, the synchronization signal manager 1350, the access probability manager 1355, and the ACK manager 1360 may be implemented at least in part in hardware or firmware. For example, one or more of the control frame manager 1325, the AMP response manager 1330, the energizing signal manager 1335, the interrogating signal manager 1340, the uplink resource selection manager 1345, the synchronization signal manager 1350, the access probability manager 1355, and the ACK manager 1360 may be implemented at least in part by at least a processor or a modem. In some examples, portions of one or more of the control frame manager 1325, the AMP response manager 1330, the energizing signal manager 1335, the interrogating signal manager 1340, the uplink resource selection manager 1345, the synchronization signal manager 1350, the access probability manager 1355, and the ACK manager 1360 may be implemented at least in part by a processor and software in the form of processor-executable code stored in memory.

The wireless communication device 1300 may support wireless communications in accordance with examples as disclosed herein. The control frame manager 1325 is configurable or configured to receive, from an AP, a control frame that solicits a response from the AMP client device, where the control frame is indicative of one or more resources associated with uplink access for the response in a shared medium subject to carrier sense type channel access. The AMP response manager 1330 is configurable or configured to perform uplink access based on the control frame to transmit the response to the AP.

In some examples, the energizing signal manager 1335 is configurable or configured to receive an energizing signal, where transmission of the response is based on reception of the energizing signal.

In some examples, the control frame includes a unicast control frame including an identifier associated with the AMP client device. In some examples, the control frame is indicative of the one or more resources being an t interframe space duration after the control frame based on the control frame being the unicast control frame.

In some examples, the control frame manager 1325 is configurable or configured to receive, within a same TXOP as the control frame, a second control frame that solicits a second response from a second AMP client device, where the control frame is indicative of one or more second resources associated with uplink access for the second response, and where the second control frame includes first information associated with the AMP client device or the second AMP device.

In some examples, a receive time of the control frame at the AMP client device includes a reference time with respect to the one or more resources.

In some examples, the control frame is a broadcast control frame or a multicast control frame. In some examples, the one or more resources include a set of resources indicated by the control frame as available for uplink random access. In some examples, the response is transmitted in a resource of the set of resources.

In some examples, the uplink resource selection manager 1345 is configurable or configured to randomly select the resource from the set of resources.

In some examples, the uplink resource selection manager 1345 is configurable or configured to select the resource from the set of resources in accordance with respective access probabilities for each resource of the set of resources.

In some examples, the access probability manager 1355 is configurable or configured to receive, from the AP via the control frame or an energizing signal associated with a TXOP that includes the set of resources, an indication of the respective access probabilities.

In some examples, the control frame manager 1325 is configurable or configured to receive, from the AP, a second version of the control frame, where the second version of the control frame is indicative of one or more second resources associated with uplink access for responses to the second version of the control frame. In some examples, the AMP response manager 1330 is configurable or configured to perform uplink access in a second resource of the one or more second resources to transmit the response to the AP.

In some examples, the control frame manager 1325 is configurable or configured to receive, from the AP, a second control frame that solicits a first retransmission of the response and is indicative of one or more second resources associated with uplink access for the first retransmission. In some examples, the AMP response manager 1330 is configurable or configured to perform uplink access in a second resource of the one or more second resources to transmit the first retransmission to the AP.

In some examples, the synchronization signal manager 1350 is configurable or configured to receive a synchronization signal at a respective beginning of each slot of the set of resources.

In some examples, the control frame manager 1325 is configurable or configured to receive a second control frame that solicits a second response from the AMP client device based on the response, where the response indicates an identifier associated with the AMP client device, where the second control frame is indicative of a second resource associated with uplink access for the second response, and where the second control frame includes the identifier associated with the AMP client device.

In some examples, the ACK manager 1360 is configurable or configured to receive a block ACK feedback for a set of responses received via the set of resources, where the set of responses includes the response.

In some examples, the set of resources are a set of slots.

In some examples, the set of resources are a set of frequency resources in a same slot.

In some examples, the interrogating signal manager 1340 is configurable or configured to receive an interrogating signal during the one or more resources, where the response is a backscatter response.

FIG. 14 shows a flowchart illustrating an example process 1400 performable by or at an AP that supports uplink access for AMP clients. The operations of the process 1400 may be implemented by an AP or its components as described herein. For example, the process 1400 may be performed by a wireless communication device, such as the wireless communication device 1200 described with reference to FIG. 12, operating as or within a wireless AP. In some examples, the process 1400 may be performed by a wireless AP, such as one of the APs 102 described with reference to FIG. 1.

In some examples, in 1405, the AP may transmit a control frame that solicits a response from an AMP client device, where the control frame is indicative of one or more resources associated with uplink access for the response in a shared medium subject to carrier sense type channel access. The operations of 1405 may be performed in accordance with examples as disclosed herein. In some implementations, aspects of the operations of 1405 may be performed by a control frame manager 1225 as described with reference to FIG. 12.

In some examples, in 1410, the AP may receive, based on the control frame, the response from the AMP client device. The operations of 1410 may be performed in accordance with examples as disclosed herein. In some implementations, aspects of the operations of 1410 may be performed by an AMP response manager 1230 as described with reference to FIG. 12.

FIG. 15 shows a flowchart illustrating an example process 1500 performable by or at an AMP client device that supports uplink access for AMP clients. The operations of the process 1500 may be implemented by an AMP client device or its components as described herein. For example, the process 1500 may be performed by a wireless communication device, such as the wireless communication device 1300 described with reference to FIG. 13, operating as or within a wireless STA. In some examples, the process 1500 may be performed by a wireless STA, such as one of the STAs 104 described with reference to FIG. 1.

In some examples, in 1505, the AMP client device may receive, from an AP, a control frame that solicits a response from the AMP client device, where the control frame is indicative of one or more resources associated with uplink access for the response in a shared medium subject to carrier sense type channel access. The operations of 1505 may be performed in accordance with examples as disclosed herein. In some implementations, aspects of the operations of 1505 may be performed by a control frame manager 1325 as described with reference to FIG. 13.

In some examples, in 1510, the AMP client device may perform uplink access based on the control frame to transmit the response to the AP. The operations of 1510 may be performed in accordance with examples as disclosed herein. In some implementations, aspects of the operations of 1510 may be performed by an AMP response manager 1330 as described with reference to FIG. 13.

Implementation examples are described in the following numbered clauses:

The following provides an overview of aspects of the present disclosure:

Aspect 1: A method for wireless communications at an AP, including: transmitting a control frame that solicits a response from an AMP client device, where the control frame is indicative of one or more resources associated with uplink access for the response in a shared medium subject to carrier sense type channel access; and receiving, based at least in part on the control frame, the response from the AMP client device.

Aspect 2: The method of aspect 1, further including: transmitting an energizing signal to the AMP client device, where reception of the response is based at least in part on transmission of the energizing signal.

Aspect 3: The method of any of aspects 1-2, further including: transmitting an indication to an energizing device to provide an energizing signal to the AMP client device prior to the one or more resources.

Aspect 4: The method of any of aspects 1-3, where the control frame includes a unicast control frame including an identifier associated with the AMP client device, and the control frame is indicative of the one or more resources being an interframe space duration after the control frame based at least in part on the control frame being the unicast control frame.

Aspect 5: The method of any of aspects 1-4, further including: transmitting, via the control frame or a second control frame, a solicitation of a second response from a second AMP client device, where the control frame or the second control frame is indicative of a time resource for the second response; and performing an interframe space recovery based at least in part on an absence of the second response during the time resource.

Aspect 6: The method of any of aspects 1-5, where a receive time of the control frame at the AMP client device includes a reference time with respect to the one or more resources.

Aspect 7: The method of any of aspects 1-6, further including: transmitting, within a same transmission opportunity as the control frame, a second control frame that solicits a second response from a second AMP client device, where the control frame is indicative of one or more second resources associated with uplink access for the second response, and where the second control frame includes information associated with the AMP client device or the second AMP client device; receiving, based at least in part on the second control frame, the second response from the second AMP client device; and transmitting, within the same transmission opportunity, a third control frame that includes second information associated with the second AMP client device or a third AMP client device.

Aspect 8: The method of any of aspects 1-3 or 6, where transmitting the control frame includes: broadcasting or multicasting the control frame, where the one or more resources include a set of resources indicated by the control frame as available for uplink random access, the method further including monitoring for responses from AMP client devices in the set of resources, the response received in a resource of the set of resources based at least in part on the monitoring.

Aspect 9: The method of aspect 8, further including: performing an interframe space recovery in a second slot of the set of resources based at least in part on an absence of a second response during the second slot.

Aspect 10: The method of any of aspects 8-9, further including: receiving a second response from a second AMP client device in a same slot of the set of resources as the response, where the control frame is a broadcast control frame; and broadcasting a second version of the control frame based at least in part on reception of the response and the second response in the same slot, where the second version of the control frame is indicative of one or more second resources associated with uplink access for responses to the second version of the control frame.

Aspect 11: The method of any of aspects 8-9, further including: receiving a second response from a second AMP client device in a same slot of the set of resources as the response, where the control frame is a multicast control frame that includes a first identifier associated with the AMP client device and a second identifier associated with the second AMP client device; and transmitting one or more second control frames that solicit a first retransmission of the response from the AMP client device and a second retransmission of the second response from the second AMP client device.

Aspect 12: The method of any of aspects 8-11, further including: transmitting a synchronization signal at a respective beginning of each slot of the set of resources.

Aspect 13: The method of any of aspects 8-12, further including: receiving a set of responses from a set of AMP client devices via the set of resources; and transmitting respective ACKs for the set of responses respective interframe space durations after the set of responses.

Aspect 14: The method of any of aspects 8-13, further including: transmitting, via the control frame or an energizing signal associated with a transmission opportunity that includes the set of resources, an indication of a respective access probability for each resource of the set of resources.

Aspect 15: The method of any of aspects 8-14, further including: transmitting a second control frame that solicits a second response from the AMP client device based at least in part on the response, where the response indicates an identifier associated with the AMP client device, where the second control frame is indicative of a second resource associated with uplink access for the second response, and where the second control frame includes the identifier associated with the AMP client device.

Aspect 16: The method of aspect 15, further including: transmitting a block ACK feedback for a set of responses received via the set of resources, where the set of responses includes the response.

Aspect 17: The method of any of aspects 8-16, where the set of resources are a set of slots or a set of frequency resources in a same slot.

Aspect 18: The method of any of aspects 1-17, further including: transmitting an interrogating signal during the one or more resources, where the response is a backscatter response.

Aspect 19: A method for wireless communications at an AMP client device, including: receiving, from an AP, a control frame that solicits a response from the AMP client device, where the control frame is indicative of one or more resources associated with uplink access for the response in a shared medium subject to carrier sense type channel access; and performing uplink access based at least in part on the control frame to transmit the response to the AP.

Aspect 20: The method of aspect 19, further including: receiving an energizing signal, where transmission of the response is based at least in part on reception of the energizing signal.

Aspect 21: The method of any of aspects 19-20, where the control frame includes a unicast control frame including an identifier associated with the AMP client device, and the control frame is indicative of the one or more resources being an t interframe space duration after the control frame based at least in part on the control frame being the unicast control frame.

Aspect 22: The method of any of aspects 19-21, further including: receiving, within a same transmission opportunity as the control frame, a second control frame that solicits a second response from a second AMP client device, where the control frame is indicative of one or more second resources associated with uplink access for the second response, and where the second control frame includes first information associated with the AMP client device.

Aspect 23: The method of any of aspects 19-22, where a receive time of the control frame at the AMP client device includes a reference time with respect to the one or more resources.

Aspect 24: The method of any of aspects 19-20 or 23, where the control frame is a broadcast control frame or a multicast control frame, the one or more resources include a set of resources indicated by the control frame as available for uplink random access, the response is transmitted in a resource of the set of resources.

Aspect 25: The method of aspect 24, further including: randomly selecting the resource from the set of resources.

Aspect 26: The method of any of aspects 24-25, further including: selecting the resource from the set of resources in accordance with respective access probabilities for each resource of the set of resources.

Aspect 27: The method of aspect 26, further including: receiving, from the AP via the control frame or an energizing signal associated with a transmission opportunity that includes the set of resources, an indication of the respective access probabilities.

Aspect 28: The method of any of aspects 24-27, further including: receiving, from the AP, a second version of the control frame, where the second version of the control frame is indicative of one or more second resources associated with uplink access for responses to the second version of the control frame; and performing uplink access in a second resource of the one or more second resources to transmit the response to the AP.

Aspect 29: The method of any of aspects 24-27, further including: receiving, from the AP, a second control frame that solicits a first retransmission of the response and is indicative of one or more second resources associated with uplink access for the first retransmission; and performing uplink access in a second resource of the one or more second resources to transmit the first retransmission to the AP.

Aspect 30: The method of any of aspects 24-29, further including: receiving a synchronization signal at a respective beginning of each slot of the set of resources.

Aspect 31: The method of any of aspects 24-27 or 30, further including: receiving a second control frame that solicits a second response from the AMP client device based at least in part on the response, where the response indicates an identifier associated with the AMP client device, where the second control frame is indicative of a second resource associated with uplink access for the second response, and where the second control frame includes the identifier associated with the AMP client device.

Aspect 32: The method of aspect 31, further including: receiving a block ACK feedback for a set of responses received via the set of resources, where the set of responses includes the response.

Aspect 33: The method of any of aspects 24-32, where the set of resources are a set of slots or a set of frequency resources in a same slot.

Aspect 34: The method of any of aspects 19-33, further including: receiving an interrogating signal during the one or more resources, where the response is a backscatter response.

Aspect 35: An AP for wireless communications, including one or more memories storing processor-executable code, and one or more processors coupled with the one or more memories and individually or collectively operable to execute the code to cause the AP to perform a method of any of aspects 1-18.

Aspect 36: An AP for wireless communications, including at least one means for performing a method of any of aspects 1-18.

Aspect 37: A non-transitory computer-readable medium storing code for wireless communications, the code including instructions executable by one or more processors to perform a method of any of aspects 1-18.

Aspect 38: An AMP client device for wireless communications, including one or more memories storing processor-executable code, and one or more processors coupled with the one or more memories and individually or collectively operable to execute the code to cause the AMP client device to perform a method of any of aspects 19-34.

Aspect 39: An AMP client device for wireless communications, including at least one means for performing a method of any of aspects 19-34.

Aspect 40: A non-transitory computer-readable medium storing code for wireless communications, the code including instructions executable by one or more processors to perform a method of any of aspects 19-34.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An access point, comprising:
a processing system that includes processor circuitry and memory circuitry that stores code, the processing system configured to cause the access point to:
transmit a control frame that solicits a response from an ambient power client device, wherein the control frame is indicative of one or more resources associated with uplink access for the response in a shared medium subject to carrier sense type channel access; and
receive, based at least in part on the control frame, the response from the ambient power client device.

2. The access point of claim 1, wherein the processing system is further configured to cause the access point to:
transmit an energizing signal to the ambient power client device, wherein reception of the response is based at least in part on transmission of the energizing signal.

3. The access point of claim 1, wherein the processing system is further configured to cause the access point to:
transmit an indication to an energizing device to provide an energizing signal to the ambient power client device prior to the one or more resources.

4. The access point of claim 1, wherein:
the control frame comprises a unicast control frame comprising an identifier associated with the ambient power client device, and
the control frame is indicative of the one or more resources being an interframe space duration after the control frame based at least in part on the control frame being the unicast control frame.

5. The access point of claim 1, wherein the processing system is further configured to cause the access point to:
transmit, via the control frame or a second control frame, a solicitation of a second response from a second ambient power client device, wherein the control frame or the second control frame is indicative of a time resource for the second response; and
perform an interframe space recovery based at least in part on an absence of the second response during the time resource.

6. The access point of claim 1, wherein a receive time of the control frame at the ambient power client device comprises a reference time with respect to the one or more resources.

7. The access point of claim 1, wherein the processing system is further configured to cause the access point to:
transmit, within a same transmission opportunity as the control frame, a second control frame that solicits a second response from a second ambient power client device, wherein the control frame is indicative of one or more second resources associated with uplink access for the second response, and wherein the second control frame comprises information associated with the ambient power client device or the second ambient power client device;
receive, based at least in part on the second control frame, the second response from the second ambient power client device; and
transmit, within the same transmission opportunity, a third control frame that comprises second information associated with the second ambient power client device or a third ambient power client device.

8. The access point of claim 1, wherein, to transmit the control frame, the processing system is configured to cause the access point to:
broadcast or multicast the control frame, wherein the one or more resources comprise a set of resources indicated by the control frame as available for uplink random access, the processing system further configured to cause the access point to monitor for responses from ambient power client devices in the set of resources, the response received in a resource of the set of resources based at least in part on the monitoring.

9. The access point of claim 8, wherein the processing system is further configured to cause the access point to:
perform an interframe space recovery in a second slot of the set of resources based at least in part on an absence of a second response during the second slot.

10. The access point of claim 8, wherein the processing system is further configured to cause the access point to:
receive a second response from a second ambient power client device in a same slot of the set of resources as the response, wherein the control frame is a broadcast control frame; and
broadcast a second version of the control frame based at least in part on reception of the response and the second response in the same slot, wherein the second version of the control frame is indicative of one or more second resources associated with uplink access for responses to the second version of the control frame.

11. The access point of claim 8, wherein the processing system is further configured to cause the access point to:
receive a second response from a second ambient power client device in a same slot of the set of resources as the response, wherein the control frame is a multicast control frame that includes a first identifier associated with the ambient power client device and a second identifier associated with the second ambient power client device; and
transmit one or more second control frames that solicit a first retransmission of the response from the ambient power client device and a second retransmission of the second response from the second ambient power client device.

12. The access point of claim 8, wherein the processing system is further configured to cause the access point to:
transmit a synchronization signal at a respective beginning of each slot of the set of resources.

13. The access point of claim 8, wherein the processing system is further configured to cause the access point to:
receive a set of responses from a set of ambient power client devices via the set of resources; and
transmit respective acknowledgments for the set of responses respective interframe space durations after the set of responses.

14. The access point of claim 8, wherein the processing system is further configured to cause the access point to:
transmit, via the control frame or an energizing signal associated with a transmission opportunity that includes the set of resources, an indication of a respective access probability for each resource of the set of resources.

15. The access point of claim 8, wherein the processing system is further configured to cause the access point to:
transmit a second control frame that solicits a second response from the ambient power client device based at least in part on the response, wherein the response indicates an identifier associated with the ambient power client device, wherein the second control frame is indicative of a second resource associated with uplink access for the second response, and wherein the second control frame includes the identifier associated with the ambient power client device.

16. The access point of claim 15, wherein the processing system is further configured to cause the access point to:
transmit a block acknowledgment feedback for a set of responses received via the set of resources, wherein the set of responses includes the response.

17. The access point of claim 8, wherein the set of resources are a set of slots or a set of frequency resources in a same slot.

18. The access point of claim 1, wherein the processing system is further configured to cause the access point to:
transmit an interrogating signal during the one or more resources, wherein the response is a backscatter response.

19. A method for wireless communications at an access point, comprising:
transmitting a control frame that solicits a response from an ambient power client device, wherein the control frame is indicative of one or more resources associated with uplink access for the response in a shared medium subject to carrier sense type channel access; and
receiving, based at least in part on the control frame, the response from the ambient power client device.

20. A non-transitory computer-readable medium storing code for wireless communications, the code comprising instructions executable by one or more processors to:
transmit a control frame that solicits a response from an ambient power client device, wherein the control frame is indicative of one or more resources associated with uplink access for the response in a shared medium subject to carrier sense type channel access; and
receive, based at least in part on the control frame, the response from the ambient power client device.
